(19) United States
(12) Patent Application Publication
(10) Pub. No.: US 2014/0050078 A1
(43) Pub. Date: Feb. 20, 2014

(54) COMMUNICATION INTERRUPTION TIME REDUCTION METHOD IN A PACKET COMMUNICATION NETWORK

(71) Applicant: HITACHI, LTD., Tokyo (JP)

(72) Inventors: Aya SATO, Yokohama (JP); Masahiko MIZUTANI, Fujisawa (JP); Masao NIIBE, Fujisawa (JP); Katsuyoshi SUZUKI, Kawasaki (JP)

(73) Assignee: HITACHI, LTD., Tokyo (JP)

(21) Appl. No.: 13/788,960

(22) Filed: Mar. 7, 2013

(30) Foreign Application Priority Data
Aug. 20, 2012 (JP) 2012-181314

(51) Int. Cl. H04L 12/24

(52) U.S. Cl. CPC H04L 41/0654
USPC 370/228

(57) ABSTRACT

In a redundant packet communication path including an active path and a backup path, user data that flows into the active path during a time when switching from the active path to the backup path is completed is transferred to a device at a protection zone receiving end to reduce a communication interruption time (traffic suspension time) in a user's point of view.

### TECHNICAL FIELD

The present invention relates to a communication system and a communication apparatus, and more particularly to a communication control technique at the time of switching a path in a communication network having an active path and a backup path.

### BACKGROUND ART

In 2010, 40 Gbps and 100 Gbps communication standards IEEE 802.3ba are defined by a standard setting organization IEEE (Institute of Electrical and Electronics Engineers, Inc.) that develops the Ethernet (registered trademark, as the case may be) standards which are communication standards of an LAN. Under the circumstances, a packet communication technology of high speed and high capacity starts to be introduced into business communication networks such as a communication carrier network.

An increase in the number of Internet users and a larger capacity of content are rapidly advanced, resulting in an important issue that a traffic exceeding the assumption of an operator occurs within the communication network to impair the quality or the continuity of information service. Also, damage when a failure occurs becomes great, and it is desirable that a communication interruption time attributable to the failure is as short as possible. For that reason, it is important to avoid the failure as well as rapidly restore the service when the communication failure occurs. As a technique for ensuring a communication continuity when the communication failure occurs while a maintenance of the packet communication network is being promoted, the standardization of an OAM (operation, administration and maintenance) technique and a protection switching technique intended for the Ethernet or an MPLS (multi-protocol label switching) network are advanced, and start to be introduced into an essential communication carrier network to ensure the reliability of the packet communication technology. The protection switching is to set another backup path different from a path used for a normal data communication in advance, and conduct a switching control when the failure occurs.

Also, in a communication network operation that emphasizes a transport performance using protection switching, it is general to separate a main signal (data signal) communicated between respective nodes from a control signal for allowing a communication carrier to control the respective nodes for operation. That is, a mutual interference between a data traffic and a control management signal of the communication apparatus is removed as much as possible. Then, in order to conduct stable operation, for example, a control line (line for transmitting the control signal) always ensures a bandwidth necessary for an operator to control and monitor a communication network.

As a system of the protection switching, 1:1 protection switching is defined. The 1:1 protection switching is configured to switch to a communication using the backup path when the active path disables a communication in a state where the communication is conducted by using only the active path. If the active path can be communicated, an extra traffic (traffic that may not conduct quality assurance when the failure occurs) is allowed to flow in the backup path for effective utilization of a resource.

As the above 1:1 protection switching, Japanese Unexamined Patent Application Publication No. 2002-281068 discloses that when a communication failure occurs in the active path, a failure detection node closest to the active path at a downstream stage detects the failure occurrence, and the node that detects the failure sequentially transfers a failure notification message including failure location information to an adjacent node. With this configuration, switching of the paths in parallel is realized according to predetermined detour information.

### SUMMARY

The 1:1 protection switching is a technique developed for the purpose of the higher reliability of the existing telephone service mainly such as sound streaming. For that reason, a best effort system such as large-capacity data backup, and large-capacity data transfer requiring a delivery conformation are not sufficiently considered. Also, there is a need to transmit and receive a control signal between edge nodes for switching the path, and both of a transmitter edge node and a receiver edge node of the redundant system conduct the path switching, autonomously, respectively. Therefore, a time is required to switch the path when the failure occurs. Because the control signal is affected by a processing delay of the relay node, a time required to restore the failure becomes longer in proportion to the number of relay nodes configuring the network. At the present when the network scale is being expanded, the influence of the processing delay becomes extremely large.

In the system disclosed in Japanese Unexamined Patent Application Publication No. 2002-281068, it is assumed that all of the detour paths become the backup paths, and to give all of the paths the same bandwidth as that of the active path is inefficient, and also unreal at the presents when the capacity of the network is increased.

An object of the present invention is to reduce a communication interruption time when a failure occurs, without ensuring an unnecessary communication bandwidth in the 1:1 protection switching.

In order to address the above problem, according to an aspect of the present invention, a communication network includes: a first device; a second device that transmits a data signal, and transmits and receives a connectivity monitoring signal with respect to the first device, through at least one of a first path and a second path; and plural third devices that configure the first path, and relays the data signal and the connectivity monitoring signal between the first device and the second device, in which when a failure occurs in the first path, the first device adds information for notifying the failure to the connectivity monitoring signal, transmits the connectivity monitoring signal added with the information for notifying the failure to the second device through the second path, and transmits the connectivity monitoring signal added with the information for notifying the failure to the plural third devices through plural third paths which is set between the respective third devices in advance, in which when the plural third devices receive the connectivity monitoring signal added with the information for notifying the failure through the respective third paths, the third devices switch the data signal from the second device to the first device, which is relayed through the first path, so as to be relayed through the respective third paths, and in which when the second device receives the connectivity monitoring signal added with the information for notifying the failure, the second device switches the data signal transmitted through the first path so as to be transmitted through the second path.

According to the aspect of the present invention, when the communication failure occurs in the path during a communication through the active path, data transfer addressed to a user can be continued through a detour path (temporarily available auxiliary path) without waiting for a time when protection switching to the backup path is completed. As a result, the amount of missing data can be reduced, and an interruption time of the data communication (service) recognized by the user can be shortened.

### BRIEF DESCRIPTION OF THE DRAWINGS

FIG. 1 is a network diagram of a communication system;

FIG. 2 is a network diagram illustrating a temporal detour path;

FIG. 3 is a functional block configuration diagram of a relay network edge device;

FIG. 4 is a path table held by the relay network edge device;

FIG. 5 is a functional block configuration diagram of a relay device;

FIG. 6 is diagram illustrating a first configuration example of a path table held by the relay device;

FIG. 7 is a diagram illustrating a path management assist table held by the relay device;

FIG. 8 is a diagram illustrating a second configuration example of the path table held by the relay device;

FIG. 9 is a sequence diagram illustrating a flow of switching a path from an active path to a backup path by the relay network edge device;

FIG. 10 is a flowchart illustrating path switching operation by an OAM control unit of the relay network edge device;

FIG. 11 is a flowchart illustrating the path switching operation by the OAM control unit of the relay device;

FIG. 12 is a flowchart illustrating the path switching operation by an input frame processing unit of the relay device;

FIG. 13 is a network diagram when a user frame high in priority is transferred to a detour path;

FIG. 14A is a user data management table (a) held by the relay device;

FIG. 14B is a user data management table (b) held by the relay device;

FIG. 15 is a flowchart illustrating static detour path transfer operation by the input frame processing unit of the relay device;

FIG. 16A is a user data management table (e) held by the relay device;

FIG. 16B is a user data management table (f) held by the relay device;

FIG. 17 is a flowchart illustrating first dynamic detour path transfer/discard determination operation by the input frame processing unit of the relay device;

FIG. 18 is a flowchart illustrating second dynamic detour path transfer/discard determination operation by the input frame processing unit of the relay device;

FIG. 19 is a network diagram for conducting a traffic control that avoids the discard of user data in the relay device;

FIG. 20 is a functional block configuration diagram of the relay device in a system of FIG. 19;

FIG. 21A is a data management table held by the relay device;

FIG. 21B is a data management table held by the relay device when a required time of the path switching is different;

FIG. 22 is a flowchart illustrating a flow of copying the user data by a data accumulation control unit;

FIG. 23 is a flow chart illustrating a flow of holding the user data by the data accumulation control unit;

FIG. 24 is a network diagram of a second communication system;

FIG. 25 is a functional block configuration diagram of the relay device;

FIG. 26 is a path table held by the relay device;

FIG. 27 is a flowchart illustrating the transfer of an APS frame by the OAM control unit of the relay device; and

FIG. 28 a network diagram illustrating a mechanism of the operation of a conventional protection switching technique.

### DETAILED DESCRIPTION

### First Embodiment

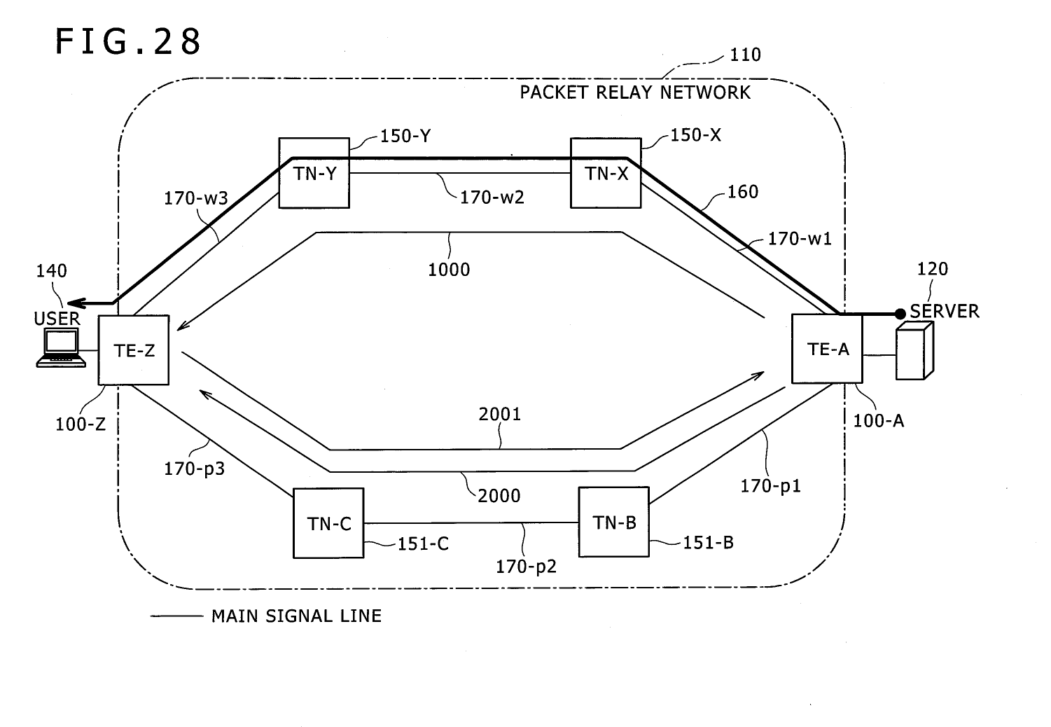

FIG. 28 a network diagram illustrating a mechanism of the operation of a conventional protection switching technique. In the network of FIG. 28, a relay network edge device TE (transport edge)-Z (100-Z) that accommodates plural user terminals (for example, PCs and company servers) 140, and a relay network edge device TE-A (100-A) that accommodates one or plural data servers 120 are connected to each other by a packet (in a transmission layer of an OSI (open systems interconnection) model, a data format having a header and a payload is called “frame”. In the following description, both of the packet and the frame are used by convention) relay network 110. In this example, a communication from the data servers 120 to the user terminals 140 is assumed, and in the following description, the TE-A (100-A) side is called “upstream side” of the packet relay network, and the TE-Z (100-Z) side is called “downstream side” thereof. Also, the packet relay network 110 is configured by the combination of a large number of relay network edge devices and relay devices. However, in this example, for simplification of description, configuration using the TE-A (100-A), the TE-Z (100-Z), and relay devices a TN (Transport Node)-X (150-X), a TN-Y (150-Y), a TN-B (151-B), and a TN-C(151-C) which are arranged to relay a communication between the TE-A (100-A) and the TE-Z (100-Z) is exemplified. In order to relay the packet from the TE-A (100-A) to the TE-Z (100-Z), this network is redundantly configured by a path passing through paths 170-w1, 170-w2, and 170-w3 as an active path 1000, and a path passing through paths 170-p1, 170-p2, and 170-p3 as a backup path 2000. In the network, a large number of relay network edge devices and relay devices are generally connected to each other in addition to the TE-A (100-A), the TE-Z (100-Z), the TN-X (150-X), the TN-Y (150-Y), the TN-B (151-B), and the TN-C (151-C) to configure the packet relay network 110.

One or plural the data servers 120 are present inside and outside the packet relay network 110. Those data servers 120 deliver user data to the user terminal 140 through the relay network edge devices such as the TE-A (100-A) configuring the packet relay network 110.

The TE-A (100-A) that has received the user data addressed to the user terminal 140 from the data server 120 transfers the user data with the use of the active path 1000 with reference to a path table 71 (to be described in detail later) within the subject device. It is assumed that a passing path of the user data when conducting a relay through the active path 1000 is a path 160.

The TE-A (100-A) and the TE-Z (100-Z) monitor the connectivity of the active path 1000, and the backup paths 2000, 2001 by an OAM function. As a signal (connectivity monitoring signal) that monitors the connectivity, specifically, there is a CCM (continuity check message) frame defined by ITU-T G.8013/Y.1731 which is transmitted to the TE-Z (100-Z) by the TE-A (100-A). The TE-A (100-A) delivers the signal to the active path 1000 and the backup path 2000 in a period T (the period T can be arbitrarily set by an operator) with the use of a CCM frame, and confirms an arrival status of the CCM frame by the TE-Z (100-Z) to monitor the connectivity. Also, likewise, as one of the connectivity monitoring signals, there is a signal that monitors and controls path switching of a redundant system, specifically, an ASP (automatic protection switching) frame defined by ITU-T G.8013/Y.1731 and ITU-T G.8031/Y.1342, which is transmitted to the TE-A (100-A) by the TE-Z (100-Z). The TE-Z (100-Z) transmits the ASP frame through the backup path 2001 normally in a 5 second period, and notifies the TE-A (100-A) whether the path switching between the active path 1000 and the backup path 2000 is necessary, or not.

In this situation, when receiving the user frame from the data server 120, the TE-A (100-A) confirms a destination according to a path table 71, and transfers the user frame to the active path 1000. In this example, if a connectivity failure occurs in the active path 1000 of the TE-Z (100-Z), that is, if the TE-Z (100-Z) never receives the CCM frame from the active path 1000 within a 3.5 frame, the TE-Z (100-Z) sets a request/state field of the APS frame, and further changes a transmission period of the APS frame to the backup path 2001 from a 5 second period to a 3.3 msec period. The TE-A (100-A) detects that the failure occurs in the active path 1000 with reference to the request/state field within the APS frame, and switches a delivery path from the active path 1000 to the backup path 2000.

A given processing time is required since the failure occurs in the active path 1000 until switching to the backup path 2000 from the active path 1000 is completed. The user frames that arrive at the TE-A (100-A) from the data server 120 since the failure occurs until the switching is completed are transferred to the active path 1000. Accordingly, those user frames do not arrive at the TE-Z (100-Z), and the communication is interrupted when being viewed from the user terminal.

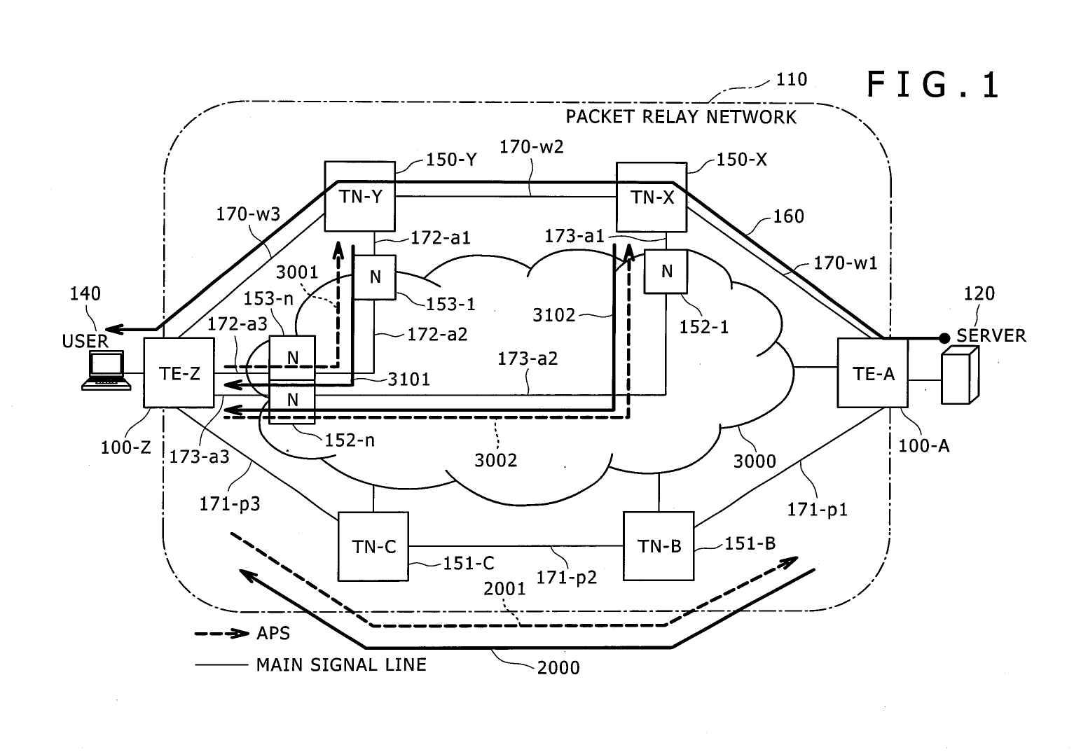

Hereinafter, embodiments will be described with reference to the accompanying drawings. FIG. 1 is a network diagram illustrating a basic configuration of a communication system assumed in this embodiment. A description of constituent elements having the same functions as those of the configurations denoted by identical symbols illustrated in FIG. 28 that has already been described will be omitted. In this example, the monitoring of a downstream connectivity, and the operation of the protection switching will be described. As described above, the active path 1000 and the backup path 2000 monitor the connectivity by the OAM function. When a communication failure occurs in the active path 1000, a time is required until the active path 1000 is switched to the backup path 2000, and a communication during the switching operation is interrupted. Under the circumstances, the user data possible to be lost in association with the switching processing is relieved with the use of an auxiliary communication path 3000 prepared inside or outside the packet relay network 110. In the auxiliary communication path 3000, detour paths 3001, 3101 and detour paths 3002, 3102 are set as temporal detour paths until the path is switched to the backup path 2000. Those detour paths are lines that connect the respective TN-Y (150-Y) and TN-X (150-X) configuring the active path 1000 to the TE-Z (100-Z). The detour paths 3001, 3101, and the detour paths 3002, 3102 are configured as physical or logical lines. A specific setup example of the detour paths will be described later.

If a communication failure occurs in the active path 1000, that is, if the TE-Z (100-Z) never receives the CCM frame from the active path 1000 within a 3.5 period, the TE-Z (100-Z) changes the APS frame delivered in the backup path 2001 direction in the 5 second period to be delivered in the backup path 2001 direction for each 3.3 msec. In this situation, likewise, the TE-Z (100-Z) transmits the APS frame to the detour paths 3001 and 3001 in addition to the backup path 2001.

The APS frame transmission to the detour paths 3001 and 3002 may be delivered in the 5 second period as with the delivery to the backup path 2001, before the communication failure occurs in the active path 1000. In this case, when the communication failure occurs in the active path 1000, the APS frame delivered in the detour path 3001 and 3002 directions in the 5 second period is changed to be delivered in the detour path 3001 and 3002 directions for each 3.3 msec.

The APS frame transmitted by the TE-Z (100-Z) arrives at the respective communication apparatuses in order farther from the TE-Z (100-Z). That is, the APS frame arrives at the TN-Y (150-Y), the TN-X (150-X), and the TE-A (100-A) in the stated order. The TN-Y (150-Y), the TN-X (150-X), and the TE-A (100-A) receive the APS frame, and determine whether the switching is necessary, or not (whether the failure is present in the active path 1000, or not) with reference to the request/state field within the APS frame. If the switching is necessary, the TN-Y (150-Y), the TN-X (150-X), and the TE-A (100-A) transfer the user frame received from the upstream side to the detour paths 3101, 3102, and the backup path 2000. Because arrival times of the APS frame at the TN-Y (150-Y), the TN-X (150-X), and the TE-A (100-A) are different from each other, the path is switched from the path 170-w3 to the detour path 3101, from the paths 170-w2 and 170-w3 to the detour path 3102, and from the entire active path 1000 including the path 170-w1 to the backup path 2000 in the stated order.

That is, up to now, the user frame until the path is switched to the backup path 2000 is discarded at a location where the failure occurs, and the data communication until the path is switched to the backup path 2000 is interrupted. However, according to this embodiment, a time during which the data communication is interrupted can be reduced with the aid of the temporal detour paths 3101 and 3102. The temporal detour paths 3101 and 3102 are not assumed to always transfer the user frame, and shared with another path of the user frame. Therefore, it is desirable that the path is switched so that the user frame passing through the detour path passes through the backup path 2000.

There are mainly two methods of structuring the auxiliary communication path 3000 (detour path 3101 and detour path 3102) for protecting the data traffic at the time of failure. One method is to set the auxiliary communication path 3000 within a data plane, and the other method is to use a control plane as the auxiliary communication path 3000. In the present specification, the data plane represents a network that conducts the processing of the user frame or the OAM frame, and the control plane represents a network that conducts the processing of a control frame. When the data plane is used, the active path 1000 can set a detour path by connecting another relay device which does not configure the backup path 2000 among the relay devices configuring the packet relay network 110. Hereinafter, a description will be given of a traffic protection method using the protection switching in each of a case in which the control plane is used as the detour path, and a case in which the data plane is used as the detour path. In the setup of the detour path, the setting method is identical between the case using the data plane and the case using the control plane (monitoring control using OpS (operation system).

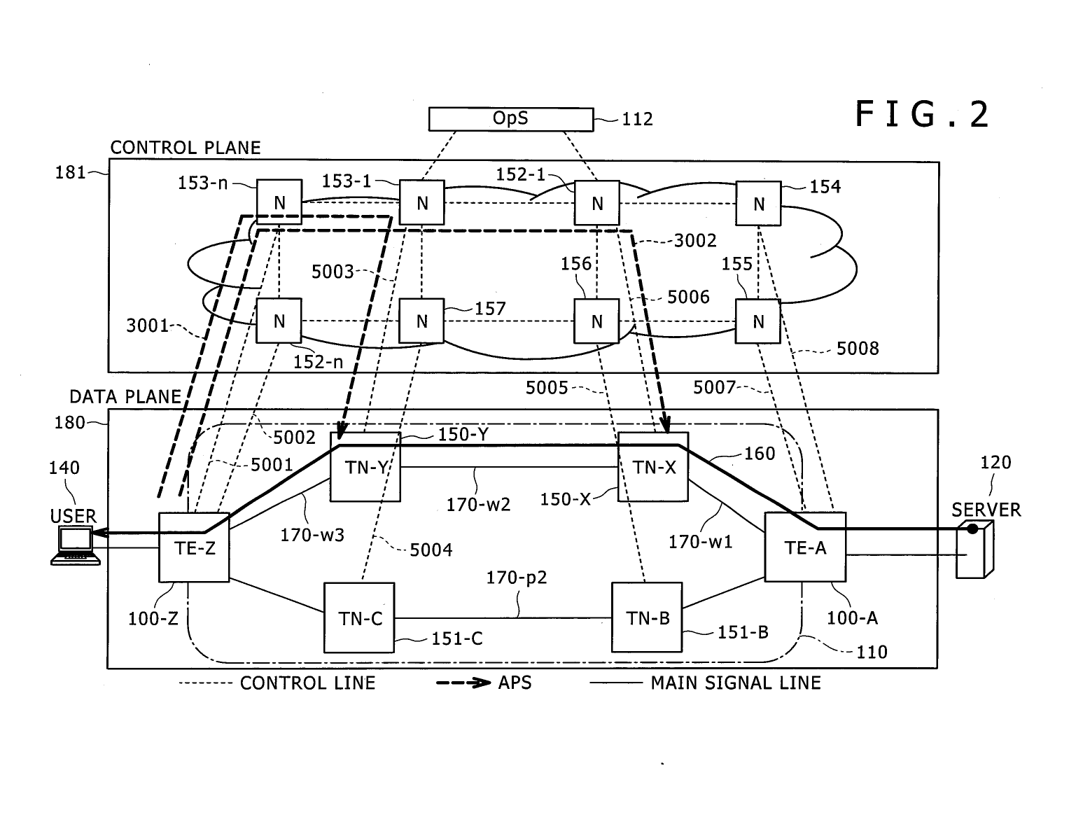

FIG. 2 is a network diagram illustrating an example of a method of setting the detour path in the network diagram of FIG. 1. In the illustration of FIG. 2, the temporal detour paths 3001 and 3002 in the network diagram. of FIG. 1 use the paths and devices within a control plane 181. The temporal detour paths 3001 and 3002 illustrated in FIG. 1 can be set by a network manager with the use of an OpS 112. The OpS represents a system that remotely conducts setup, monitoring, control, and examination of the system such as registration work of a base station and a subscriber, and an examination failure monitoring. In this example, a control terminal having its software is denoted by OpS 112.

The OpS 112 can access to the communication apparatuses TE-A (100-A), the TE-Z (100-Z), the TN-X (150-X), and the TN-Y (150-Y) configuring the packet relay network 110 through any one or plural communication apparatuses N152-1, N152-n, N153-1, N153-n, N154, N155, N156, N157 configuring the control plane 181 which is a control network. The OpS 112 can mutually transmit communication network operation information including path setup information and operation/monitoring information to the communication apparatus configuring a data plane 180 that conducts the processing of the user frame or the OAM frame through the control plane 181. In this figure, the respective communication apparatuses within the data plane 180 are connected to the communication apparatuses within the control plane 181, and can communicate directly or indirectly with the OpS 112. If those conditions are satisfied, a path configuration method of the control plane may be different from that in FIG. 2.

Paths for controlling the communication apparatuses within the data plane 180 by the OpS 112 are called “control lines”, and paths in which a main signal flows are called “main signal lines”. In FIG. 2, the control lines are denoted by reference numeral 5001 to 5008. The OpS 112 can control not only the control lines but also the communication apparatus of the data plane 180 through the control lines and the main signal line. As usual, a bandwidth of the control lines is narrower than that of the main signal lines. In general, a communication state of the data plane 180 is monitored by the OpS 112 through the control lines, and the protection is implemented within the data plane 180.

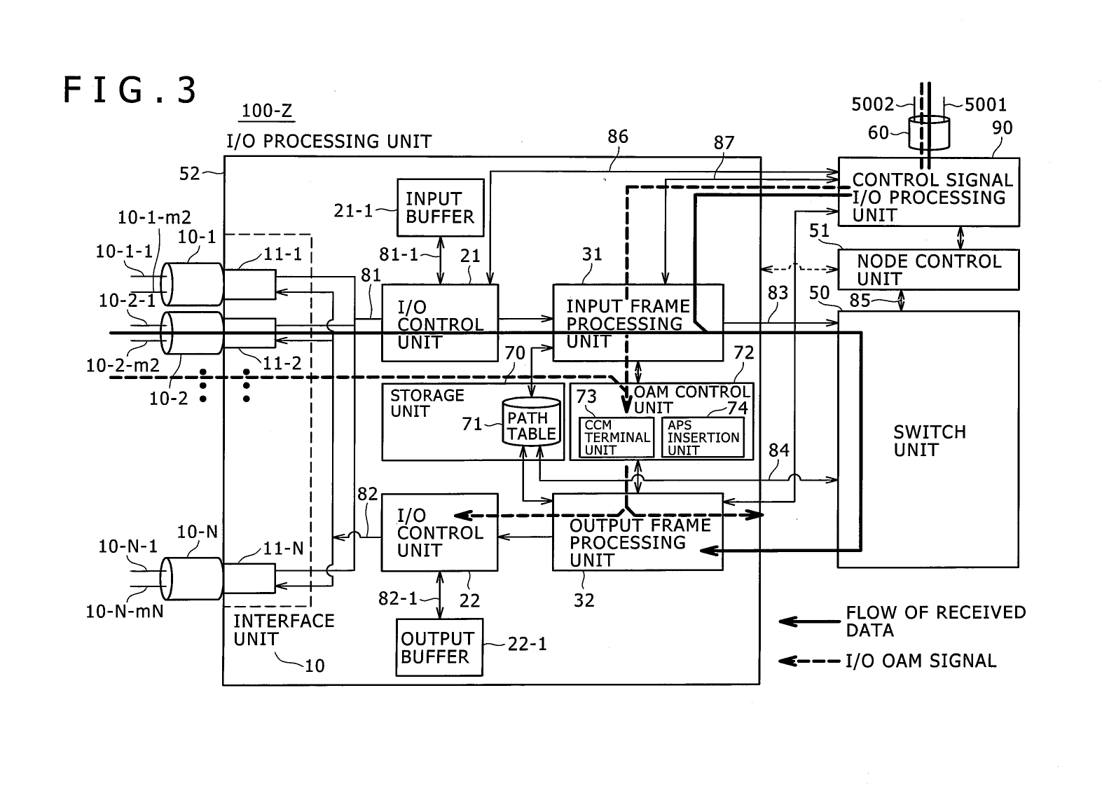

FIG. 3 is a functional block configuration diagram illustrating a device configuration example of the TE-Z (100-Z). A device management and communication signal processing of the TE-Z (100-Z) will be described with reference to FIG. 3. In order to connect with another communication apparatus, a server, or a terminal device, the TE-Z (100-Z) includes one or plural communication interfaces 11-1 to 11-N. Those interfaces 11 are included in interface units 10, and signals received through the interfaces 11 are accumulated in an input buffer 21-1. As functional blocks that process the received signals, there are provided I/O control units 21, 22, an input frame processing unit 31, an output frame processing unit 32, and an OAM control unit 52. The I/O control unit 21 starts write into the input buffer 21-1, and conducts a timing instruction when transferring a frame from the input buffer 21-1 to the input frame processing unit 31. When a signal input is detected by the interface units 10, a frame arrival is notified the I/O control unit 21 of, and an input signal is recorded in the input buffer 21-1. Paths 81 and 81-1 are signal paths used for monitoring and controlling transfer of a signal including a frame (main signal) from the interface units 10 to the I/O control unit 21 and the input buffer 21-1, or an in-device state (or communication status) including a new frame arrival/non-arrival state, respectively.

In FIG. 3, lines 10-1-1 to 10-N-mN connected to the interface units 10 represent physical lines or logical lines. In general, the signal frame is logically identified with the use of a VLAN (virtual local area network) or an MPLS (multi-protocol label switching) tag. For example, if the interfaces 10-1 to 10-N are regarded as physical interfaces, the respective interfaces can include 10-1-1 to 10-1-m1, 10-2-1 to 10-2-m2, and 10-N-1 to 10-N-mN. In the individual logical lines, plural logical lines can be further set. For example, when plural VLAN tags is used, or when plural shim headers used for frame transfer is inserted by the MPLS, a logical line having a multistep layer can be configured.

When the received frame is transferred from the input buffer 21-1 to the input frame processing unit 31, the input frame processing unit 31 conducts the type determination of the received frame (protocol identification, main signal/control signal identification), the extraction of a frame header, a destination confirmation, and the assignment, conversion, and deletion of header information. In the destination confirmation of the received frame, the input frame processing unit 31 extracts the header information indicative of a destination of the received frame, and checks the extracted information against the path table 71. Communication path information for transmitting the frame toward an appropriate destination is held in the path table 71 for each of the received frames. The communication path information includes an identifier of the interface for transmission and header information to be assigned to the frame at the time of transmission.

The frames whose destinations are determined are distributed for each of the destinations by a switch unit 50. That is, the switch unit 50 functions to connect between plural interface boards. For example, the frame is transferred for an interface board having a physical/logical interface to which the frame is to be transmitted, on the basis of the above-mentioned header information (header information of a frame body or an internal header (for example, destination port identifier) information used only within the device) attached to the frame input to the switch unit 50. The path 83 is a signal path through which the frame is transmitted from the input frame processing unit 31 to the switch unit 50. In FIG. 3, a correlation relationship of the functional blocks in the communication apparatus is illustrated with simplification. Therefore, although a specific realization method is not illustrated, it is general to use a configuration in which a signal processing substrate having a function of the switch unit 50 and an interface substrate including the individual interfaces are connected to each other with the use of a back plane. In general, it is not uncommon to amount only the switch unit 50 on another substrate in FIG. 3. Differences of the specific mounting method are irrelevant to essences of the present invention and this embodiment, and therefore its detailed description will be omitted. In determination of a forwarding destination (interface board or interface group) of an input frame, the switch unit 50 checks the header information of the frame against the path table in a storage unit 70 internally provided to determine the forwarding destination. When determining the forwarding destination of the frame to be input, the switch unit 50 transfers the frame to the output frame processing unit 32 of the forwarding destination as an output frame.

From the above flow, the frame that is received from the switch unit 50 by the output frame processing unit 32 is a frame to be transferred to the external by the interface unit 10 on the interface board to which the output frame belongs. A path 84 is a signal path for transmitting the frame to the input frame processing unit 31 from the switch unit 50. The output frame processing unit 32 is a block for conducting final processing until the output frame is transmitted for the interface units 10, and conducts the same processing as that in the input frame processing unit 31. That is, the output frame processing unit 32 records the output frame in an output buffer 22-1, and conducts a timing instruction when transferring the frame to the interface unit 10.

Also, the output frame processing unit 32 conducts processing of the header information and transmission processing (frame order adjustment) for each of the priorities. The output frame processing unit 32 selects the communication interfaces 11-1 to 11-N to which the output frame received from the switch unit is specifically transmitted. The processing of the header information is implemented, for example, when there are required the deletion of an internal header used for frame processing within the device, a change, addition or deletion of the header information when a protocol is different between an input side and an output side, or read processing of the frame information for recording the processing status.

A control signal I/O processing unit 90 processes the control signal. A node control unit 51 is a control unit provided for controlling the entire TE-Z (100-Z). The node control unit 51 conducts the setting, update, and management of the path table 71 on the basis of the information set through the OpS 112 by the operator to determine an output destination to the user frame input to the TE-Z (100-Z).

The operator conducts the setting of the above-mentioned path information on the respective devices (for example, in FIG. 1, TE-A (100-A), TN-X (150-X), TN-Y (150-Y)) other than the TE-Z (100-Z) to realize a communication path (for example, the above-mentioned active path 1000) designed by the operator as the entire network. In addition, the node control unit 51 monitors the states of the respective configuration blocks of the TE-Z (100-Z) such as the OAM control unit 52 or the switch unit 50, and notifies the OpS 112 of the state of the device as occasion demands. The operator receives the above-mentioned notification through the OpS 112 to grasp the status of the device, and realize the maintenance.

In this example, the main signal physical lines 10-1 to 10-N conform to the standards of 10GBASE-SX defined by, for example, IEEE803.2ae. Also, it is assumed that the control signal physical line 60 conforms to the standards of 10GBASE-T defined by IEEE802.3an. The interface standards recited here are consistently exemplary, and the present invention is not limited to the interface prescription in this device.

Subsequently, characteristic functions of the TE-Z (100-Z) will be described. The TE-Z (100-Z) monitors the connectivity with the TE-A (100-A) with the aid of the OAM technique. A processing method of the OAM frame (CCM frame and APS frame) will be described below.

When the input frame processing unit 31 identifies the frame as the CCM frame when determining the type of received frame, the processing is terminated by a CCM termination unit 73 within an OAM control unit 72. Also, the OAM control unit 72 generates the APS frame by an APS insertion unit 74, and transmits the APS frame to the backup path 2001 and the detour paths 3001, 3002 through the switch unit 50. When transmitting the APS frame to the detour paths 3001 and 3002, the OAM control unit 72 transmits the APS frame for the control plane 181 through a control signal physical line 60 (and the logical line when logical lines 5001 and 5002 are set).

The OAM control unit 72 monitors an arrival period of the CCM frame by the CCM termination unit 73. If the CCM termination unit 73 never receives the CCM frame from the active path within a 3.5 period, the OAM control unit 72 determines that a communication failure occurs in the active path 1000. If the failure is detected, the APS insertion unit 74 changes the APS frame transmission period in which the APS frame is transmitted to the backup path 2001 and the detour paths 3001, 3002 in a 5 second period in a normal state to 3.3 msec, and embeds state transition information (for example, 1011 representing an active signal failure) in the request/state field for requesting the communication path switching.

After the failure occurs, the user frame transmitted by the TE-A (100-A) through the active path 1000 until the path switching processing in the TE-A (100-A) is completed arrives at the TE-Z (100-Z) through the detour paths 3101 and 3102. In this situation, the user frame does not arrive at the TE-Z (100-Z) from a normal in-data plane interface 11-1 through the interface 11-N, but arrives at the TE-Z (100-Z) through the logical lines 5001 and 5002, or the control signal physical line 60. That is, the node control unit 51 transfers the received user frame to the I/O control unit 21 through a path 86, and the I/O control unit 21 conducts the termination or transmission processing on the user frame as with the frame received from the data plane 180. At the time of transmitting the APS frame including a switching request flag, the node control unit is arranged to receive the user frame through the logical lines 5001, 5002, and the control signal physical line 60. That is, the node control unit accepts a control line usage in the user frame which is not permitted in the normal state (change of the receiver filter), and conducts processing of the failure occurrence in the I/O control unit 21, the buffer securement for the user frame reception through the node control unit 51, and the identifier notification of data to be received. A path 85 is a signal path for mutually transmitting the frame by the node control unit 51 and the switch unit 50.

As another mounting method, the reception processing of the user frame may be conducted by the node control unit 51 instead of the input frame processing unit 31. The mounting method can be realized by a method of terminating the user frame, and delivering the user frame to the input frame processing unit 31 through a path 87, with the use of a signal processing function for processing the control signal in a normal state. As still another method, the OAM control unit 72 can notify the node control unit 51 of information (parameter) necessary for the OAM control including the identifier of the path in which the failure occurs at the time of transmitting the APS frame (or the node control unit holds those pieces of information in advance), to thereby complete the processing of all the user frames within the node control unit 51, and also transfer the user frame to the switch unit 50.

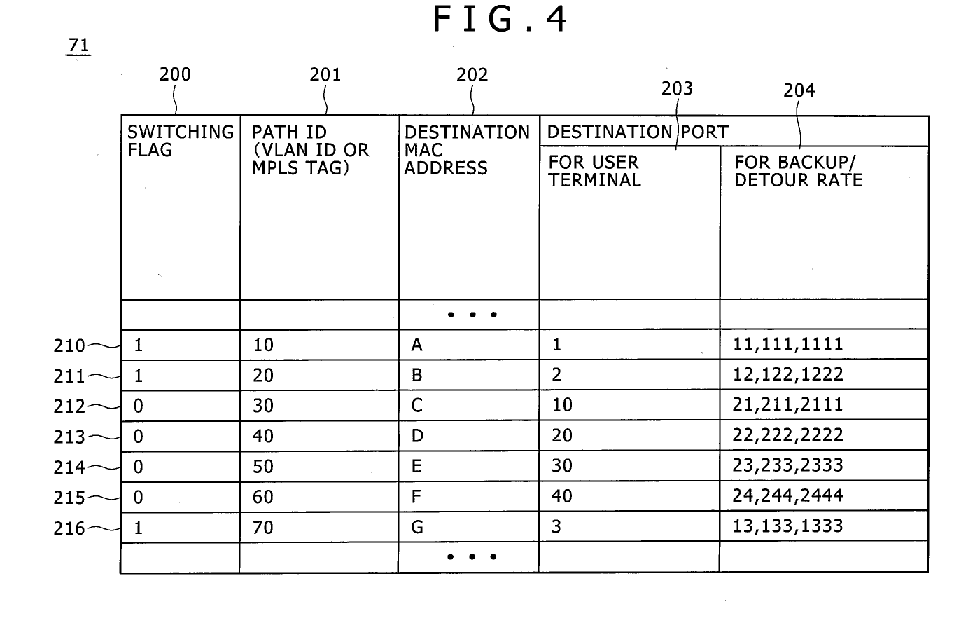

FIG. 4 illustrates a table configuration example of the path table 71 which is held by the TE-Z (100-Z). Data 210 to 216 represents the entries of the table. This table is statically set by the OpS 112 prior to start of the communication service, for example, in a general communication carrier network. In this table, there are stored a path ID (identification) (VLAN ID or MPLS tag) 201, a destination MAC address 202, and a destination port (transmission interface set for each path ID) No. 203, for managing and operating the packet relay network 110 by the operator. For the purpose of indicating the path ID 201, the VLAN tags and the shim headers can be used in plurality, or plural combinations of the VLAN IDs and the MPLS labels can be used. The path ID 201 and the destination MAC address 202 are included as the header frame to be processed, and can be used as a search key when searching this table. For example, the destination MAC address 202 can be used to specify the destination port No. when plural destination identifiers belonging to the same VLAN are present. At the time of searching the path table 71, the destination port No. 203 defined for each of the entries indicated by the search key is extracted to determine the header information necessary when processing the destination and transfer of the frame.

Also, the path table 71 of the TE-Z (100-Z) holds port Nos. 204 for the backup path 2001, and the detour paths 3001, 3002 which are paths for transmitting the APS frame when the communication failure occurs in the active path. At the time of the normal frame transfer processing, the destination port No. 203 of this table is searched to transfer the received frame. Because the user frame is transferred from the TE-Z (100-Z) toward the user terminal 140, the destination port No. 203 is always used in the transfer processing of the user frame. On the other hand, in transmission of the APS frame when the communication failure occurs, an APS frame transmission target (monitoring target in the OAM) path is searched from this table with the use of the path ID 201, and the destination port Nos. 204 for backup/detour path of the entry is extracted to assign the header information addressed to the path. That is, in generation and transmission of the APS frame, the port Nos. 204 for the backup/detour path described in the entry of the target path is always used. When the APS frame is transmitted to not only the backup path but also one or plural detour paths as in this embodiment, plural port Nos. is stored in the port Nos. 204 for the backup/detour path as illustrated in FIG. 4. As a result, the plural port Nos. is extracted from the port Nos. 204 for the backup/detour path registered for the APS frame transmission target path, and the APS frame is transmitted for the entire extracted port Nos.

Also, a switching flag 200 can be provided in this table. In the flag, “0” or “1” is inserted depending on whether the path ID 201 (input path of the received frame) of each entry corresponds to the active path 1000, or the backup/detour path. The user frame received from the backup/detour path is transferred to the user terminal 140 after the arrival status of the frame is confirmed so as to prevent the loss or duplication of data by the TE-Z (100-Z). Under the circumstances, in the entries where the switching flag is “1” such as the failure occurs in the active path 1000, there is a need to monitor the arrival status of the frame received from the backup/detour path preferentially. For example, auxiliary processing can be conducted such that the buffers of the I/O control unit 21 and the input frame processing unit 31 are opened preferentially.

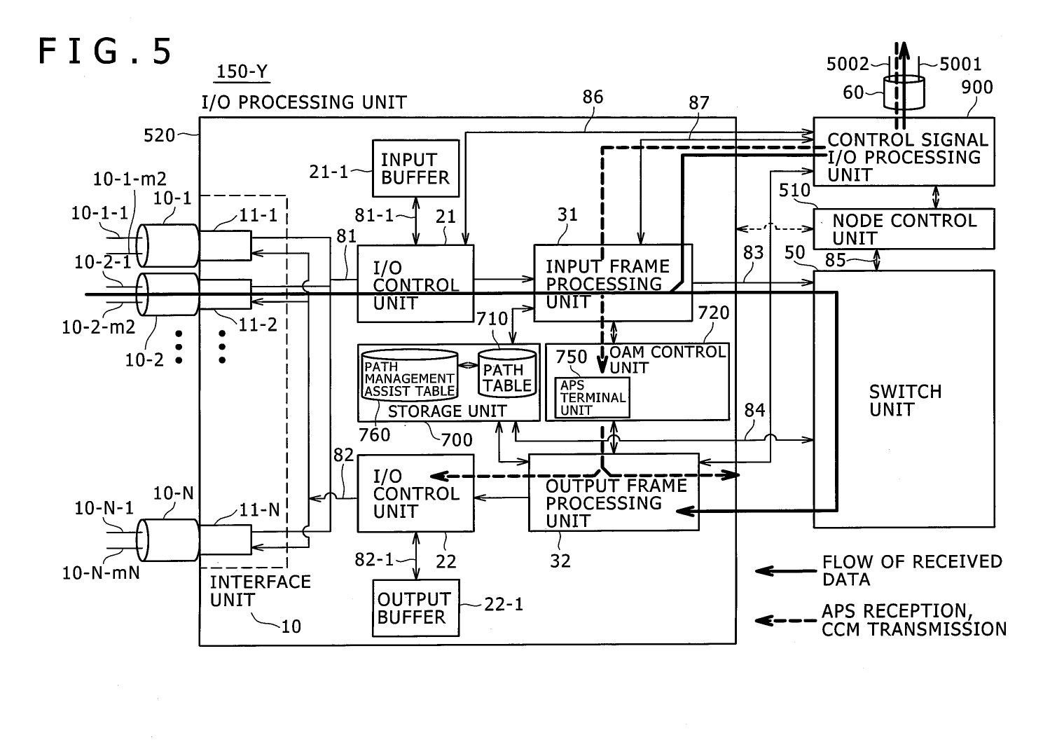

FIG. 5 is a functional block configuration diagram illustrating a device configuration example of the TN-Y (150-Y). The device management and the communication signal processing in the TN-Y (150-Y) will be described with reference to FIG. 5. A description of the same functions as those in the TE-Z (100-Z) will be omitted. Hereinafter, the characteristic functions of the TN-Y (150-Y) will be described.

The important functions of the TN-Y (150-Y) are to terminate the APS frame and confirm whether the path switching is necessary, or not, and to transfer the user frame flowing in the path to be switched for the TE-Z (100-Z) in association with the path switching. The TN-Y (150-Y) normally receives the APS frame through the detour path 3001 or the control signal physical line every 5 seconds, and terminates the APS frame by an APS termination unit 750 within an OAM control unit 720 which is a processing unit. When receiving the frames other than the control frame, a node control unit 510 transfers the frame to the I/O control unit 21. As another mounting method, an APS frame identification function may be provided within the node control unit 510, and only the APS frame may be selectively transferred to the I/O control unit 21 or the input frame processing unit 31. Also, as another mounting example, a functional block corresponding to the APS termination unit 750 may be installed within the node control unit 510, the APS frame may be terminated, and whether the switching is necessary, or not, may be determined. To summarize the switching procedure, it is necessary to (1) determine whether the path switching is necessary, or not, by the node control unit 510 or the OAM control unit 720, (2) extract the path identifier for identifying the path to be switched to extract the user frame flowing in the path, (3) further identify the communication path that has been switched, and (4) transfer the user frame to the path. A part of the procedure (1) and the procedure (3) are processed by the OAM control unit 720. The data extraction in the procedure (2) and the frame transfer in the procedure (4) are conducted by the input frame processing unit.

When the node control unit 510 or the APS termination unit 750 receives the APS frame in which information for transmitting the state transition requiring the switching operation is embedded in the request/state field, the node control unit 510 or the OAM control unit 720 instructs an I/O processing unit 520 to switch the transfer path of the user data for the subject path. The I/O processing unit 520 that receives an instruction for the path switching transfers the frame received by the input frame processing unit 31 to the detour path with reference to a path table 710 (or the path table 710 and a path management assist table 760 (to be described later) of a storage unit 700.

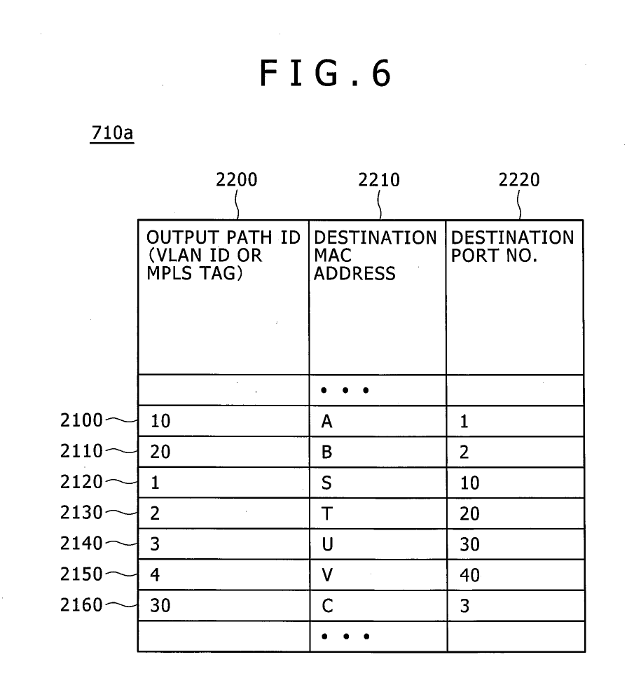

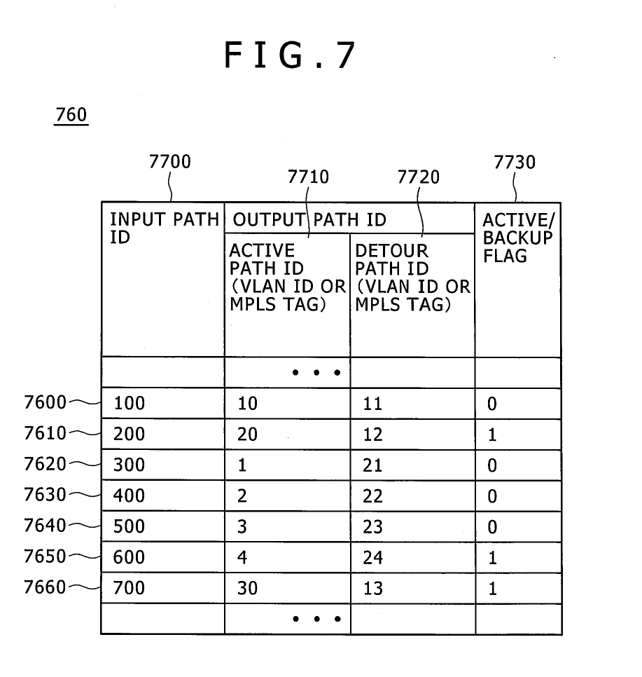

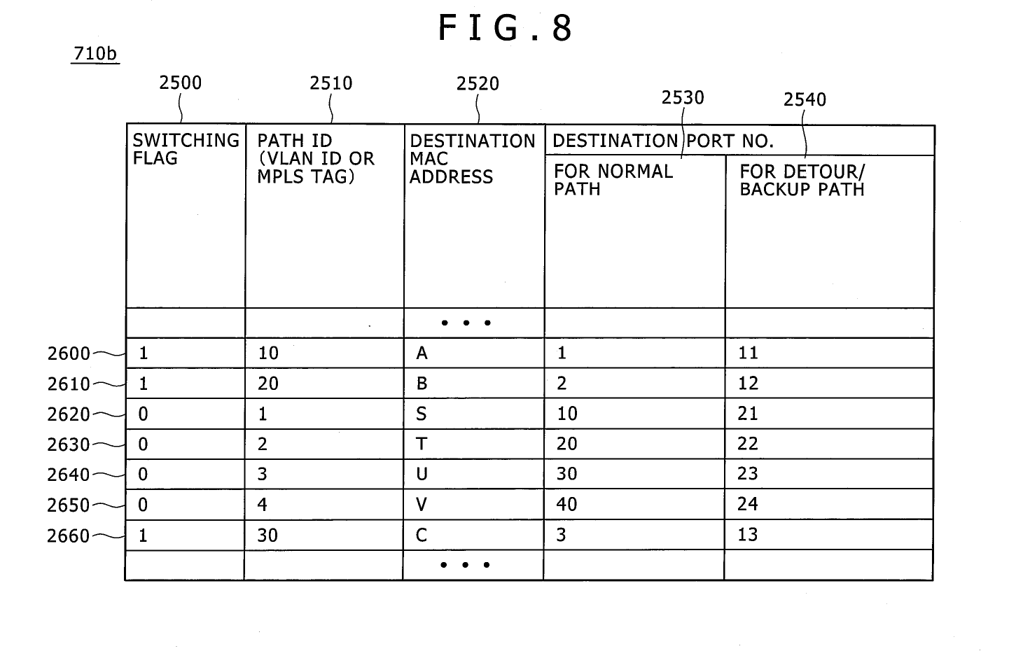

FIG. 6 illustrates a first configuration example (path table 710a) of a table of the path table 710 held by the TN-Y (150-Y). FIG. 8 illustrates a second configuration example (path table 710b) of the table of the path table 710. Also, FIG. 7 illustrates a path management assist table 760 held by the TN-Y (150-Y). Two means can be used in conducting the path switching. A first means (hereinafter referred to as “means A”) is a method of mutually switching the active path and the backup path which are different in the path ID from each other (with reference to FIGS. 6 and 7). A second means (hereinafter referred to as “means B”) is a method of switching the path by changing a distribution destination of the user data without changing the path ID to be switched (with reference to FIG. 8).

In the path table 710a of FIG. 6 are stored an output path ID (VLAN ID or MPLS tag) 2200 for identifying the output path when transmitting the received frame, a destination MAC address 2210, and a destination port No. 2220.

In the path management assist table of FIG. 7 are stored an input path ID (VLAN ID or MPLS tag) 7700 for identifying the input path of the received frame, an active path ID ((VLAN ID or MPLS tag) 7710 for identifying the active path and a detour path ID (VLAN ID or MPLS tag) 7720 for identifying the detour path as the output path IDs, and an active/backup identification flag 7730 for identifying the path (the active system or the detour system) that outputs the received frame.

In the path table 710b of FIG. 8 are stored a path ID (VLAN ID or MPLS tag) 2510, a destination MAC address 2520, a normal path destination port No. 2530 for identifying the active path and a detour/backup path destination port No. 2540 for identifying the detour path and the backup path as the destination port Nos., and a switching flag 2500 for switching the path that outputs the received frame.

First, the means A holds the path ID of the detour path 3101 which is paired with the path ID of the path 170-w3 in the tables (FIGS. 6 and 7) in advance, separately, and refers to the entry of the path ID corresponding to the detour path 3101 when the failure occurs. In this situation, if the entry using the normal path is set to “0”, and the entry using the detour path is set to “1” with the use of the active/backup identification flag 7730 in advance, the table reference can easily be implemented. Specifically, in the user frame transmitted from the TE-A (100-A) which is an upstream edge device in the TN-Y (150-Y), the active/backup identification flag 7730 of the entry is confirmed with reference to the input path ID 7700 in the path management assist table 760. If the active/backup identification flag 7730 of the user frame is “0”, the active path ID 7710 is extracted as the output path ID. If the active/backup identification flag 7730 is “1”, the detour path ID 7720 is extracted as the output path ID. The output path ID 2200 of the path table 710a in FIG. 6 is searched with the extracted output path ID as a key. The output path ID 2200 is transferred to the downstream TE-Z (100-Z) with reference to the destination MAC address 2210 or the destination port No. 2220 of the corresponding entry.

Also, the means B is a method for changing the distribution destination of the user frame without changing the path ID. With the use of the switching flag 2500 in the table of FIG. 8, in the case of “0”, the normal path destination port No. 2530 of the entry is referred to, and in the case of “1”, the detour/backup path destination port No. 2540 is referred to. As a result the normal path destination port Nos. 2530 and 2540 described in the same entry can be selectively used to output the user frame. In the means A, there is a need to register only any destination port No. of the normal path (active system) and the detour path (detour system) in each entry. On the other hand, in the means B, both information of the normal path/backup path is registered in each entry in advance, and the destination port No. is switched with the use of the switching flag 2500.

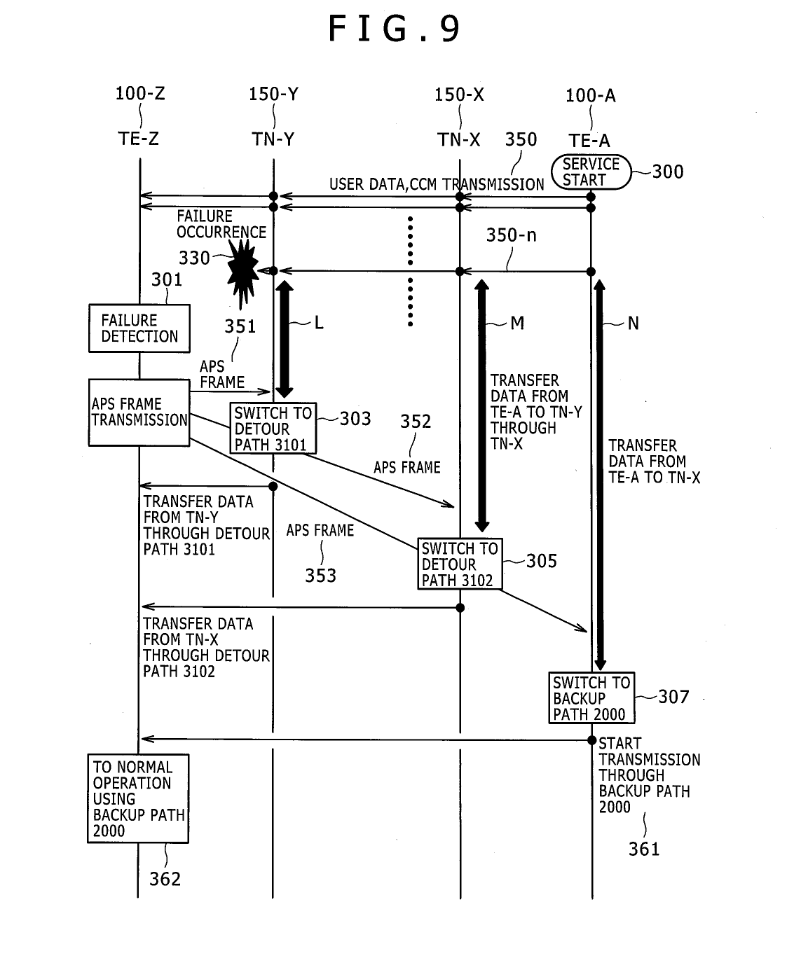

FIG. 9 is a sequence diagram illustrating a flow of switching the path from the active path 1000 to the backup path 2000 by the TE-Z (100-Z). After starting a service (300), the TE-A (100-A) transmits the CCM frame and the user frame to the TE-Z (100-Z) through the active path 1000 (350 to 350-n). When a communication failure 330 occurs, and the TE-Z (100-Z) detects the failure (301), the TE-Z (100-Z) delivers the APS frame in which the request/state field within the APS frame is changed to understand that the failure occurs to the TN-Y (150-Y), the TN-Y (150-Y), and the TE-A (100-A) (351, 352, 353). When receiving the APS frame, the TN-Y (150-Y) switches the user frame received from the TE-A (100-A) to be transferred to the detour path 3101 (303). When receiving the CCM frame, the TN-Y (150-Y) may transfer the CCM frame to the detour path 3101, or may continue to transfer the CCM frame to the active path 170-w3 as it is. Then, when receiving the APS frame, the TN-X (150-X) switches the user frame received from the TE-A (100-A) to be transferred to the detour path 3102 (305). When receiving the CCM frame, the TN-X (150-X) may transfer the CCM frame to the detour path 3102, or may continue to transfer the CCM frame to the active path 170-w3 as it is. Finally, when receiving the APS frame, the TE-A (100-A) switches the user frame received from the data server 120 to be transferred to the backup path 2000, as with the TN-Y (150-Y) and the TN-X (150-X) (307). After switching, the TE-Z (100-Z) transmits the CCM frame and the user frame transmitted through the active path 1000 to the backup path 2000 (361), and starts the normal operation using the backup path 2000 (362).

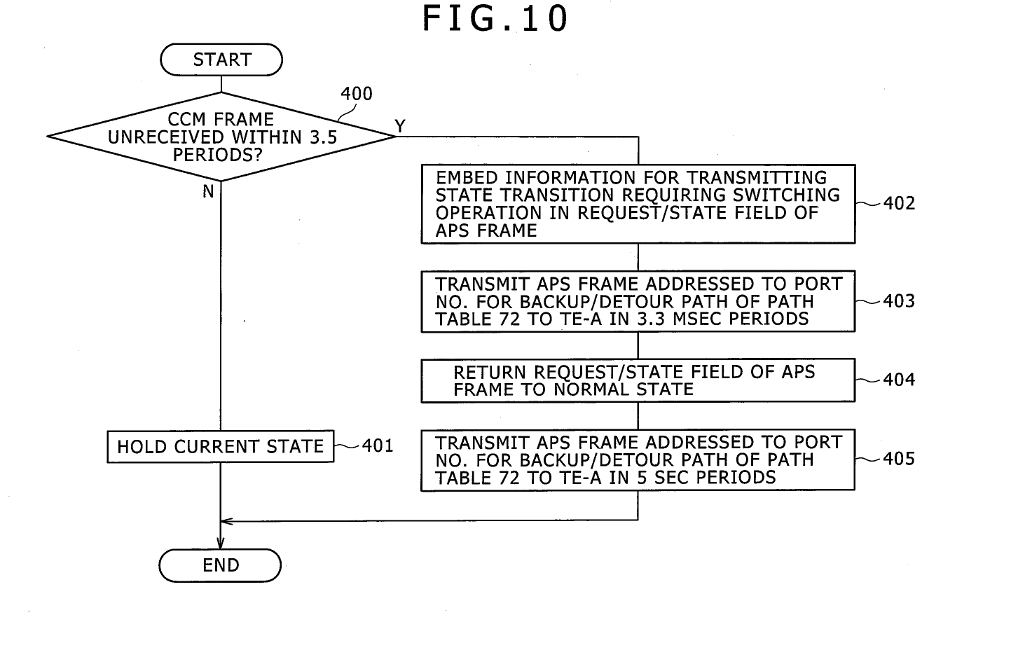

FIG. 10 is a flowchart illustrating the path switching operation by the OAM control unit 72 of the TE-Z (100-Z). The OAM control unit 72 monitors the reception state of the CCM frame (400). If the OAM control unit 72 receives the CCM frame within the 3.5 period at least once (n in 400), the OAM control unit 72 determines that there is no failure in the active system, and continues reception from the active path (401). On the other hand, if the TE-Z (100-Z) never receives the CCM frame within the 3.5 period (y in 400), the OAM control unit 72 determines that a failure occurs in the active system, and embeds the information for transmitting the state transition requiring the switching operation in the request/state field of the APS frame which has been transmitted to the backup path (402). Further, the OAM control unit 72 transmits the APS frame to the TE-A (100-A), the TN-Y (150-Y), and the TN-X (150-X) through the temporal backup path 2001, and the detour paths 3001, 3002 in the 3.3 msec period with reference to the backup/detour path port No. of the path table 71 set by the OpS 112 in advance three times (403). After the APS frame has been transmitted three times, the OAM control unit 72 returns the request/state field to a normal state (the same value as that before the communication failure occurs) (404), and transmits the APS frame to the TE-A (100-A), the TN-Y (150-Y), and the TN-X (150-X) in the 5 second period which is the same as that before the communication failure occurs (405). The transmission periods and the number of transmissions of the CCM frame and the APS frame described in the embodiment of the present invention are values based on recommended values of the standard, and the setting value may be arbitrarily changed according to an operating policy of the operator.

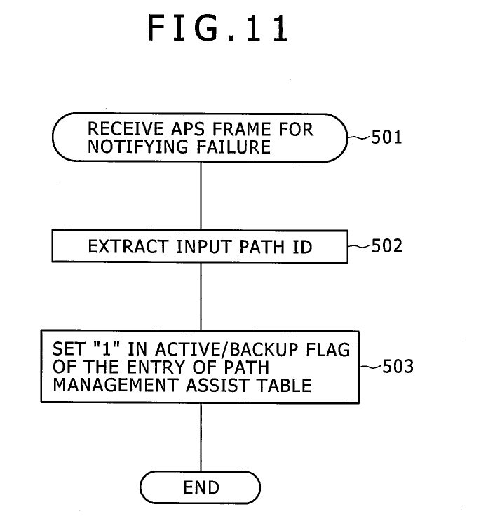

FIG. 11 is a flowchart illustrating the path switching operation by the OAM control unit 720 of the TN-Y (150-Y). The TN-X (150-X) also conducts the same operation as that of the TN-Y (150-Y), and the operation of the TN-Y (150-Y) will be described as an example. When receiving the APS frame for notifying the failure (501), the OAM control unit 720 extracts the input path ID of the APS frame (502). Thereafter, the OAM control unit 720 sets the active/backup identification flag 7730 of the entry to “1” with reference to the path management assist table 760 (503).

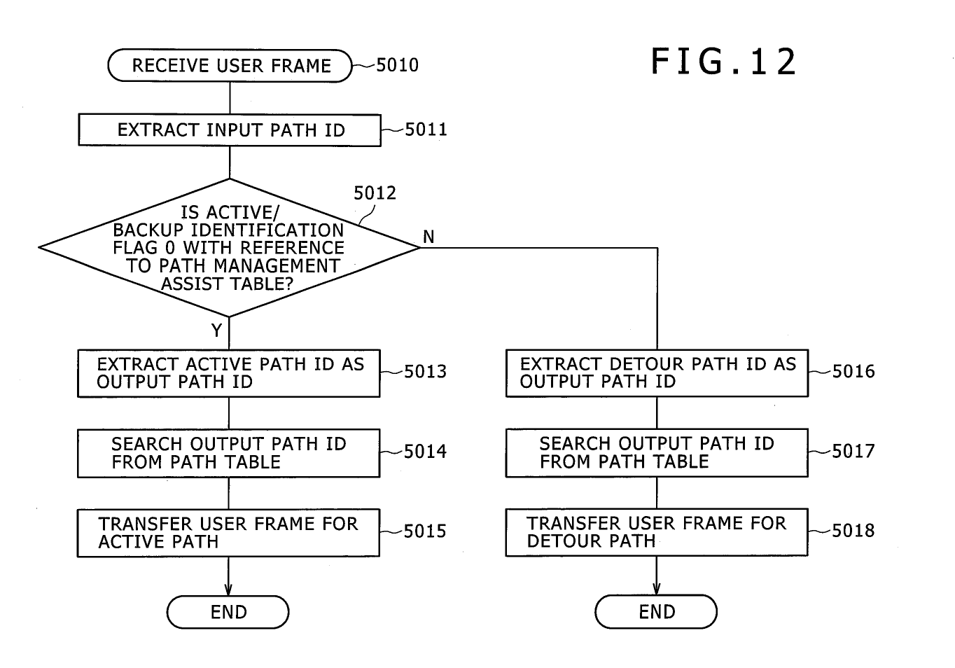

FIG. 12 is a flowchart illustrating the path switching operation by the input frame processing unit 31 of the TN-Y (150-Y) or the TN-X (150-X). When receiving the user frame (5010), the input frame processing unit 31 extracts the input path ID from the header information of the user frame (5011). Thereafter, the input frame processing unit 31 determines whether the active/backup identification flag 7730 of the entry is “0”, or not, with reference to the path management assist table 760. If the active/backup identification flag 7730 is “0” (y in 5012), the input frame processing unit 31 extracts the active path ID 7710 as the output path ID (5013), and searches the destination MAC address 2210 and the destination port No. 2220 in the path table 710 with the active path ID 7710 as a key (5014). Thereafter, the input frame processing unit 31 transfers the user frame to the active path (5015). If the active/backup identification flag 7730 of the entry is “1” with reference to the path management assist table 760 in 5012 (n in 5012), that is, if the active/backup identification flag 7730 is “1”, the input frame processing unit 31 extracts the detour path ID 7720 as the output path ID (5016), and searches the destination MAC address 2210 and the destination port No. 2220 in the path table 710 with the output path ID 7720 as a key (5017). Thereafter, the input frame processing unit 31 transfers the user frame to the detour path (backup path) (5018).

From the above viewpoint, when the failure occurs in the active path, the failure time of the service recognized by the user can be reduced until the active path is switched to the backup path. A comparison of the normal 1:1 protection switching and the failure time of the service according to this embodiment will be described with reference to FIG. 9.

In the related-art 1:1 protection switching, a time N is taken until switching from the TE-Z (100-Z) to the TE-A (100-A). On the other hand, in this embodiment, if a communication failure 330 occurs between the TN-Y (150-Y) and the TE-Z (100-Z), a time L until the switching to the detour path 3101 is completed in 303 is taken. The time L becomes a failure time of the service recognized by the user. It is apparent that the time L is shorter in the communication interruption time than the time N. In addition, if a communication failure 330 occurs between the TN-Y (150-Y) and the TE-X (100-X), a time M until the switching to the detour path 3101 is completed in 303 is taken. It is apparent that the time M is shorter in the communication interruption time than the time N.

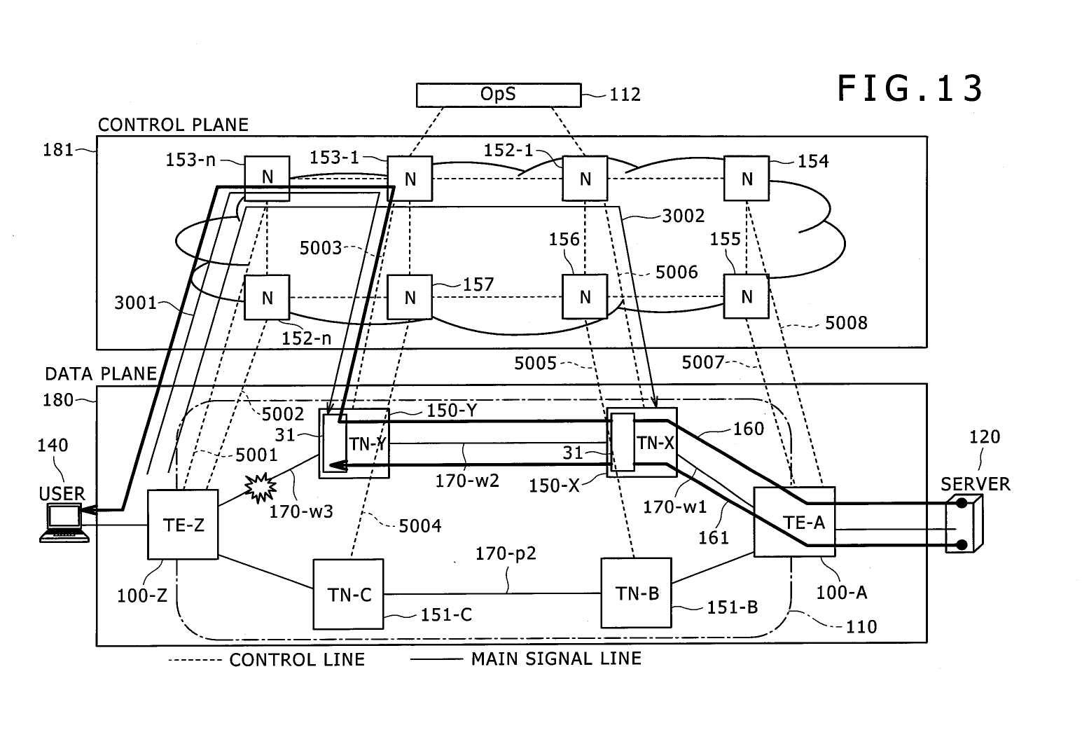

FIG. 13 is a network diagram when the communication failure occurs in the active path, and user data high in priority is transferred to the detour path. In a configuration in which the respective communication apparatuses within the data plane 180 are connected to the communication apparatuses within the control plane 181, and can communicate directly or indirectly with the OpS 112, the OpS 112 can control the communication apparatuses within the data plane 180 through the control lines and the main signal lines. However, as usual, the bandwidth of the control lines is narrower than that of the main signal lines. Because the bandwidth of the control lines is narrower, when the user data is transferred to the control lines as the temporal detour path until the active path is switched to the backup path during the communication failure occurring in the active path, if the capacity of the user data is large, the user data may be discarded even if the data is high in the priority. In this example, the user data high in the priority can be set to be transferred to the detour path and surely arrive at the user. The detail will be described with reference to the following drawings. The user data high in the priority is, for example, data high in urgency (the Japan Meteorological Agency, tsunami/tornado early warning, etc.), or moving pictures.

The transfer of the user data high in the priority to the detour path is conducted by discriminating the priority of the user data with reference to a user data management table (the detail will be described later) in the input frame processing unit 31 within the TN-Y (150-Y) or the TN-X (150-X), and determining whether the user data is transferred to the detour path, or discarded (or accumulated in the buffer and retransmitted after the failure is restored). The priority of the user data can be identified, for example, by the CoS value. In this network diagram, the communication failure occurs in the path 170-w3, and the priority of the user data is identified by the input frame processing unit 31 within the TN-Y (150-Y). A main signal line 160 high in the priority is identified to be high in the priority in the input frame processing unit 31, and transferred to the detour path whereas a main signal line 161 low in the priority is discarded (or stored in the buffer) without being transferred to the detour path in the input frame processing unit 31.

A user data management table 770 is a table that is referred to when the input frame processing unit 31 determines whether the user data is transferred or discarded (or accumulated in the buffer, and retransmitted after the failure is restored) when receiving the APS frame in which the information for transmitting the state transition requiring the switching operation is embedded in the request/state field by the APS termination unit 750. The storage unit 700 of the TN-Y (150-Y) or the TN-X (150-X) described in FIG. 5 holds the user data management table 770.

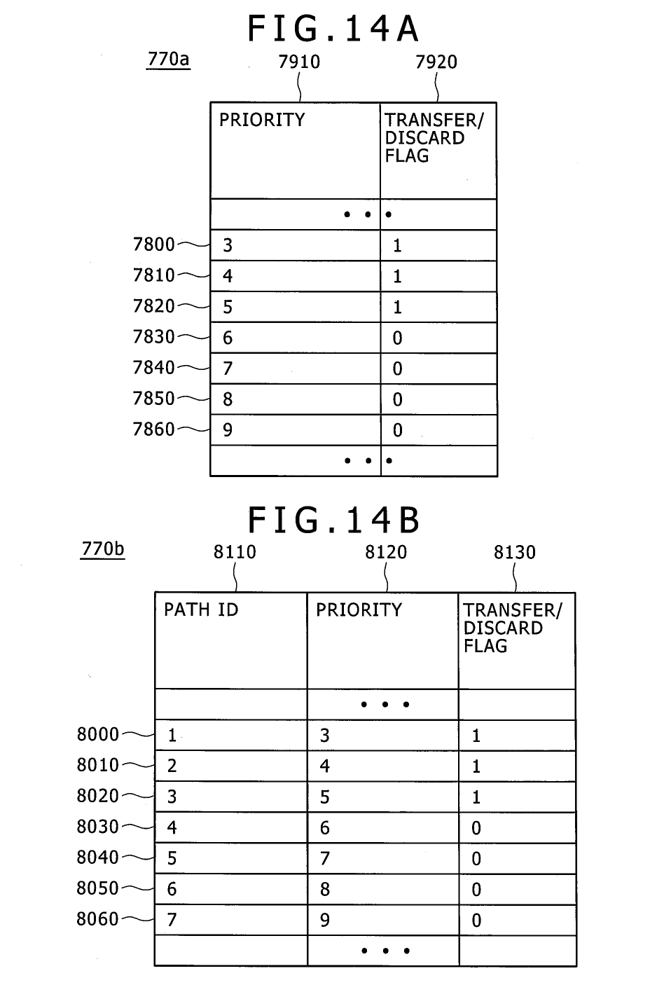

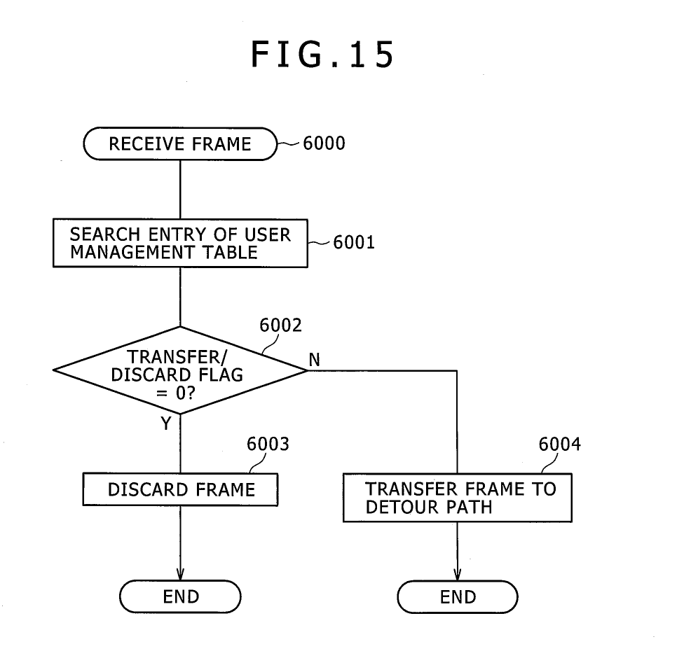

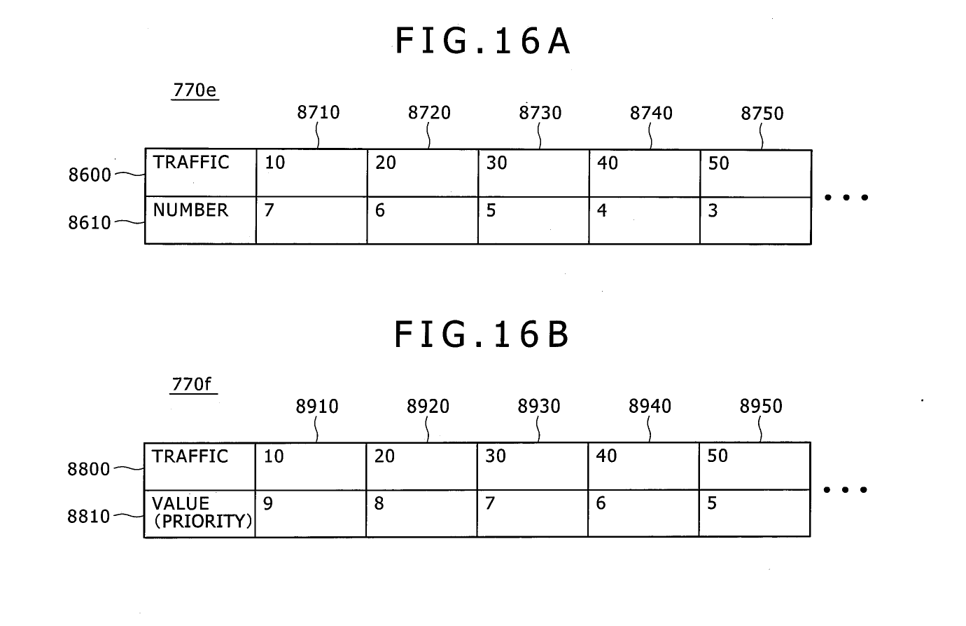

A method of determining whether the user data is transferred to the detour path, or discarded, includes two methods, that is, a statically determining method and a dynamically setting method. The statically determining method will be described with reference to FIGS. 14 and 15, and the dynamically determining method will be described with reference to FIGS. 16, 17, and 18. In the following description, the input frame processing unit 31 determines whether the user data is transferred to the detour path, or discarded. However, the determination is not limited to the input frame processing unit 31 if a functional unit having the same function is provided.

FIGS. 14A and 14B illustrate the user data management table 770 that is held by the TN-Y (150-Y) in the case of statically determining whether the user data is transferred to the detour path, or discarded by the input frame processing unit 31. There are two means for identifying the priority on the basis of the user data management table 770. A first means is a method of identifying the priority by the CoS value assigned to the frame, and named “means A”. A second means is a method of storing the VLAN ID of an Ethernet frame, a MAC address, and the MPLS tag of the MPLS frame as the path ID in a table, and identifying the priority according to the path ID, and named “means B”. It is assumed that the table referred to when using the means A is a user data management table (a) 770a (FIG. 14A), and the table referred to when using the means B is a user data management table (b) 770b (FIG. 14B).

First, the user data management table (a) 770a will be described. This table is set by the operator with the aid of the OpS 112 prior to start of the communication service, for example, in a general communication carrier network. Data 7800 to 7860 represent the entries of this table. In this table is stored a priority 7910 embedded in the user frame. The priority represents the CoS value within the user frame. It is discriminated whether the user frame is transferred to the detour path, or discarded by the input frame processing unit 31, with reference to the priority 7910. In this example, data smaller in a value of the priority 7910 is higher in the priority. That is, data 7800 whose priority 7910 is “3” is “high” in the priority, and data 7860 whose priority 7910 is “9” is “low” in the priority.

The above discriminating method can provide, for example, a transfer/discard flag 7920 which is information for specifying whether the transfer (relay) of the user data to the detour path is enabled, or not, in this table in advance. “0” or “1” is inserted in this flag according to whether the user frame of each priority 7910 is discarded by the input frame processing unit 31, or transferred (relayed) to the detour path. This flag can be statically set by the OpS 112 prior to the start of the communication service. Also, this flag can be arbitrarily changed by the operator during the service.

Subsequently, the user data management table (b) 770b will be described. This table is also set by the operator with the aid of the OpS 112 prior to start of the communication service as with the user data management table (a) 770a. Data 8000 to 8060 represent the entries of this table. In this table are stored the VLAN ID of the Ethernet frame, the MAC address, and the MPLS tag of the MPLS frame as a path ID 8110. Also, the operator stores a priority 8120 corresponding to the path ID in advance. As a result, the priority 8120 can be identified with the path ID 8110 as a search key. The I/O processing unit 520 discriminates whether the user frame is transferred to the detour path, or discarded by the input frame processing unit 31, with reference to the priority 8120. The high priority and the low priority of the values of the priority 8120 are the same as those in FIG. 14A.

The above discriminating method can provide a transfer/discard flag 8130 in this table in advance, for example, as with the means A. The operation of this flag is identical with that of the means A, and therefore its description will be omitted. In this example, the entries are stored in the lower order of the priority, but may be arrayed not in the priority order but at random. Even in such a case, the operator can set the priority in the transfer/discard flag 8130 in advance. In this example, if this flag 8130 is set, the priority 8120 may not be set.

FIG. 15 is a flowchart illustrating transfer/discard determination operation by the input frame processing unit 31 of the TN-Y (150-Y) when statically determining whether the user frame is transferred to the detour path, or discarded. This flowchart illustrates the operation of transferring the received user frame to the detour path after the TN-Y (150-Y) detects that the communication failure occurs in the active path. In this example, the operation of determining the forwarding destination of the frame will be described with reference to the user data management table (a) 770a.

When receiving the user frame (6000), the input frame processing unit 31 extracts the priority from the CoS value of the frame, and searches the entry in the user data management table (a) 770a with the priority as a search key (6001). Then, the input frame processing unit 31 discriminates whether the user frame is transferred to the detour path, or not, with reference to the transfer/discard flag 7920 of the hit entry (6002). When the transfer/discard flag 7920 is 0, that is, when the user frame is not transferred to the detour path (y in 6001), the input frame processing unit 31 discards the user frame (6003). Alternatively, instead of the discard, the input frame processing unit 31 can accumulate the user frame in the input buffer 21-1, and retransmit the user frame after the failure is restored. Alternatively, the input frame processing unit 31 may continue to transfer the user data to the active path. When the transfer/discard flag 7920 is 1, that is, when there is a need to transfer the user frame to the detour path (n in 6001), the input frame processing unit 31 further transfers the user frame to the detour path with reference to the path table 710 (6004). In this example, the user fame can include the OAM frame for monitoring the data communication (for example, the OAM frame that arrives at the TE-A (100-A) from the external, or the OAM frame that is mutually transmitted or received by the TE-A (100-A) and the TE-Z (100-Z) for the purpose of monitoring the data communication by the packet relay network 110 end-to-end. Similarly, in the OAM frame, the input frame processing unit 31 extracts the priority from the CoS value, and searches the entry in the user data management table (a) 770a with the priority as a search key, to thereby determine the transfer/discard operation to the detour path.

FIGS. 16A and 16B illustrate the user data management table 770 that is held by the TN-Y (150-Y) in addition to FIGS. 14A and 14B when dynamically determining whether the user data is transferred to the detour path, or discarded. There are two means for identifying the priority on the basis of the user data management table 770 as in the statically determining method. A first means is a method of identifying the priority by the Cos value assigned to the frame, and named “means C”. A second means is a method of storing the VLAN ID of an Ethernet frame, a MAC address, and the MPLS tag of the MPLS frame as the path ID in a table, and identifying the priority according to the path ID, and named “means D”. It is assumed that the table referred to when using the means C is a user data management table (a) 770a (FIG. 14A), and the table referred to when using the means D is a user data management table (b) 770b (FIG. 14B). Also, it is assumed that the table commonly referred to by the means C and the means D is a user data management table (e) 770e (FIG. 16A) or a user data management table (f) 770f (FIG. 16B). Values stored in the transfer/discard flags 7920 and 8130 of the user data management table (a) 770a (FIG. 14A) and the user data management table (b) 770b (FIG. 14B) are determined according to the user data management table (e) 770e and the user data management table (e) 770e, respectively. It is determined whether the user data management table (e) 770e, or the user data management table (f) 770f is referred to according to whether the respective entries of the user data management table (a) 770a (FIG. 14A) and the user data management table (b) 770b (FIG. 14B) are lined in the priority order, or not. If the respective entries of the user data management table (a) 770a and the user data management table (b) 770b are lined in the priority order, both of the user data management table (e) 770e (FIG. 16A) and the user data management table (f) 770f (FIG. 16B) can be used. If the entries are not lined in the priority order, the user data management table (f) 770f (FIG. 16B) is referred to. Because the respective table referring methods of the means C and the means D are identical with the means A and the means D, the means C will be described.

In the user data management table (e) 770e (FIG. 16A), a traffic 8600 and the number 8610 are stored in entries 8710 to 8750. In this example, the traffic represents the traffic of the respective detour paths. Also, the number represents how many transfer/discard flags from the top of the user data management table (a) 770a (FIG. 14A) the bit is allocated to according to the traffic of the respective detour paths. For example, if the traffic of the detour path is 30 with reference to the user data management table (e) 770e (FIG. 16A), the number 8610 is 3 with reference to the entry 8730. Under the circumstances, the transfer/discard flags of the three entries from top of the user data management table (a) 770a (FIG. 14A) (from the priority “high”) can be set to 1. The traffic 8600 and the number 8610 can be statically set by the OpS 112 prior to start of a communication service. Also, this flag can be arbitrarily changed by the operator during the service. The traffic of the detour path can be measured by providing an output frame processing unit, for example, within the node control unit 510 as a measurement unit, and monitoring the output frame.

In the user data management table (f) 770f (FIG. 16B), a traffic 8800 and a priority value 8810 are stored in entries 8910 to 8950. In this example, the priority value 8810 represents a maximum priority for stopping the user data from being transferring to the detour path. For example, if the traffic of the detour path is 30 with reference to the user data management table (e) 770e (FIG. 16A), the priority value 8810 is 5 with reference to the entry 8930. That is, in this case, because the user data of the priorities 3, 4, and 5 is transferred to the detour path, the transfer/discard flag is set to 1 for the entries in which the priority 7920 of the user data management table (a) 770a is 3, 4, and 5. According to this method, even if the entries of the user data management table (a) 770a (FIG. 14A) are not lined in the priority order, the value of the priority 7910 is designated, and a value of the transfer/discard flag can be dynamically set.

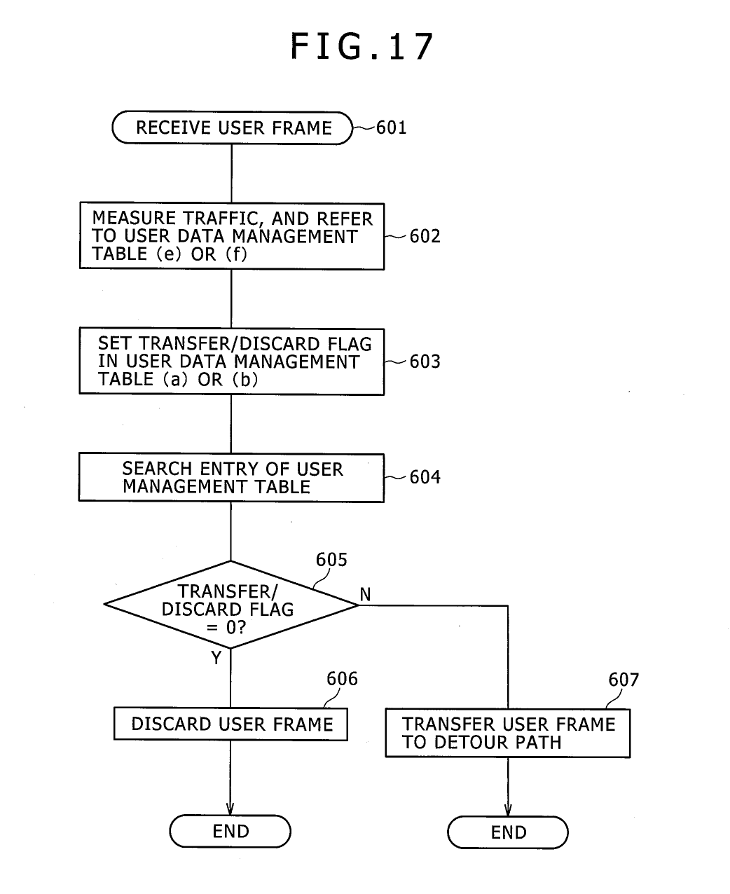

FIG. 17 is a flowchart illustrating first detour path transfer/discard determination operation by the input frame processing unit 31 of the TN-Y (150-Y) when it is dynamically determined whether the user data is transferred to the detour path, or discarded. This flowchart illustrates the operation of detecting that the communication failure occurs in the active path by the TN-Y (150-Y), and determining whether the received user frame is transferred to the detour path, or discarded. When receiving the user frame (601), the input frame processing unit 31 acquires the traffic of the detour path from the measurement unit, refers to the user data management table (e) 770e or the user data management table (f) 770f (602), and sets the transfer/discard flag of the user data management table (a) 770a or the user data management table (b) 770b according to the traffic (603). For example, if the traffic of the acquired detour path is 15, the input frame processing unit 31 refers to the user data management table (e) 770e, and understands that the number N is 6 because the traffic 15 corresponds to the traffic 20 or lower. In this case, the transfer/discard flags of the six entries from top of the user data management table (a) 770a are set to “1”. Then, the input frame processing unit 31 discriminates whether the user frame is transferred to the detour path, or not, with reference to the transfer/discard flag 7920 of the hit entry (605). If the transfer/discard flag 7920 is “0”, that is, when the user data is not transferred to the detour path (y in 605), the input frame processing unit 31 discards the user frame (606). If the transfer/discard flag 7920 is “1”, that is, if there is a need to transfer the user frame to the detour path (n in 605), the input frame processing unit 31 transfers the user frame to the detour path with reference to the path table 710 (607).

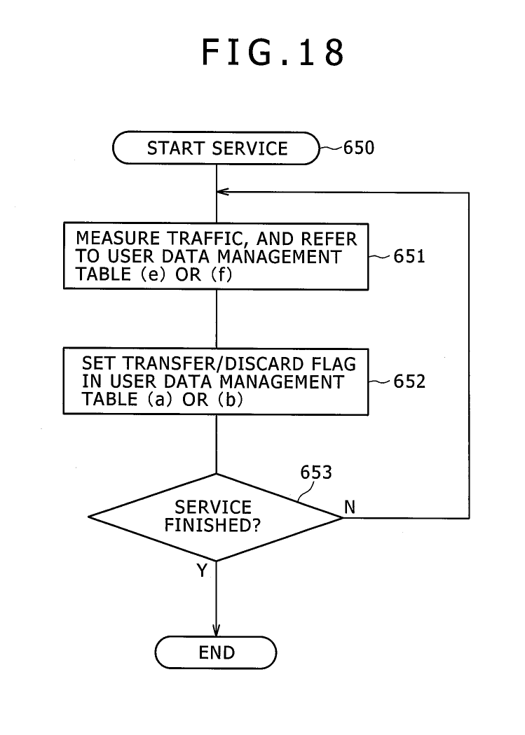

FIG. 18 is a flowchart illustrating second detour path transfer/discard determination operation by the input frame processing unit 31 of the TN-Y (150-Y) when it is dynamically determined whether the user data is transferred to the detour path, or discarded. This flowchart is to periodically measure the traffic of the detour path, and set the transfer/discard flag of the user data management table (a) 770a and the user data management table (b) 770b. The input frame processing unit 31 measures the traffic of the detour path after start of the service (for example, operation start of the packet relay network 110). Through the same method as that in FIG. 16, the input frame processing unit 31 refers to the user data management table (e) 770e or the user data management table (f) 770f (651), and sets the transfer/discard flag of the user data management table (a) 770a or the user data management table (b) 770b according to the traffic (652). The input frame processing unit 31 periodically repeats the above operation until the service is finished, and conducts the same transfer/discard operation as that described with reference to FIG. 15 at the time of receiving the user frame. At the time when the service is finished (y in 653), the measurement of the traffic is terminated.

From the above viewpoint, it is possible to transfer only the user data high in the priority when temporarily transferring the user data to the detour path. As a result, the user data is prevented from being discarded regardless of the level of the priority when the bandwidth of the priority is compressed, and the user data high in the priority can surely arrive at the user terminal 140.

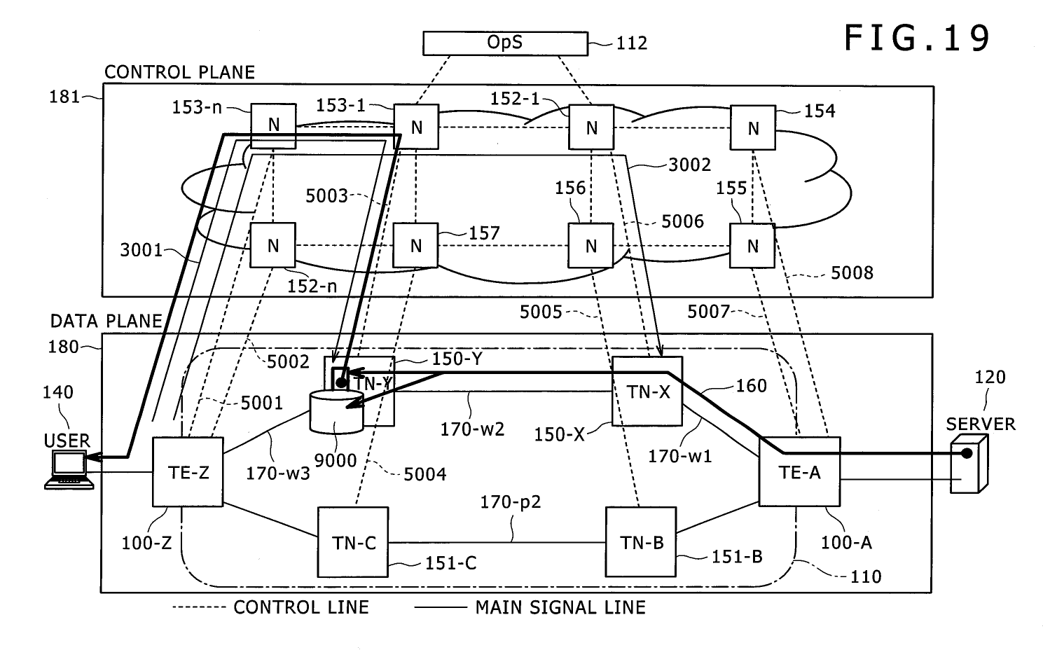

FIG. 19 is further a network diagram illustrating a system that conducts a traffic control for avoiding the discard of the user data to be protected in the relay device in the embodiment illustrated in FIG. 2. The network includes the control plane 181 and the data plane 180, and elements configuring this system are identical with those in FIG. 2. This embodiment has an advantage that an influence of the failure is released particularly when a failure occurs in a terminal zone of the active path in a communication network having a redundant configuration, that is, in a zone close to the receiver edge node TE-Z (100-Z). However, a slight time is required until the switching from the main signal line 160 to the backup path 2000 is completed. Therefore, the user data flowing into the TN-Y (150-Y) continues to be transmitted to the main signal line 160 in which the failure occurs until the switching processing of the forwarding destination to the detour path, for example, in the TN-Y (150-Y) is completed. As a result, the user data is discarded without arriving at the TE-Z (100-Z). In order to avoid the data missing, the following method is applied.

The TN-Y (150-Y) includes a data accumulation buffer 9000 that holds the user data for a given time when transferring the user data. The TN-Y (150-Y) stores a copy of the user data in the data accumulation buffer 9000 in order to protect the user data in a normal state where no failure occurs in the path. If the failure occurs in a path of the destination until the detour path of the forwarding destination is set to enable a communication since a time at which the failure occurs, the user data is read from the data accumulation buffer 9000, and retransmitted. This method is named “means E”. As another method, a storage time until the user data is transmitted from the TN-Y (150-Y) to the TE-Z (100-Z) is set in the normal state where no failure occurs in the path, and during this time, the user data is temporarily held in the data accumulation buffer 9000. As a result, the traffic can be prevented from being idly transmitted to the path in which the connectivity is lost while a time is required for the failure detection and the path switching. This method is named “means F”. In this method, the missing of the user data traffic can be substantially completely avoided. For that reason, this method is effective in a reduction in the total traffic in a case having a data retransmission function of a TCP (transmission control protocol)/IP particularly such as download of a large volume data or a large scale data backup between data centers.

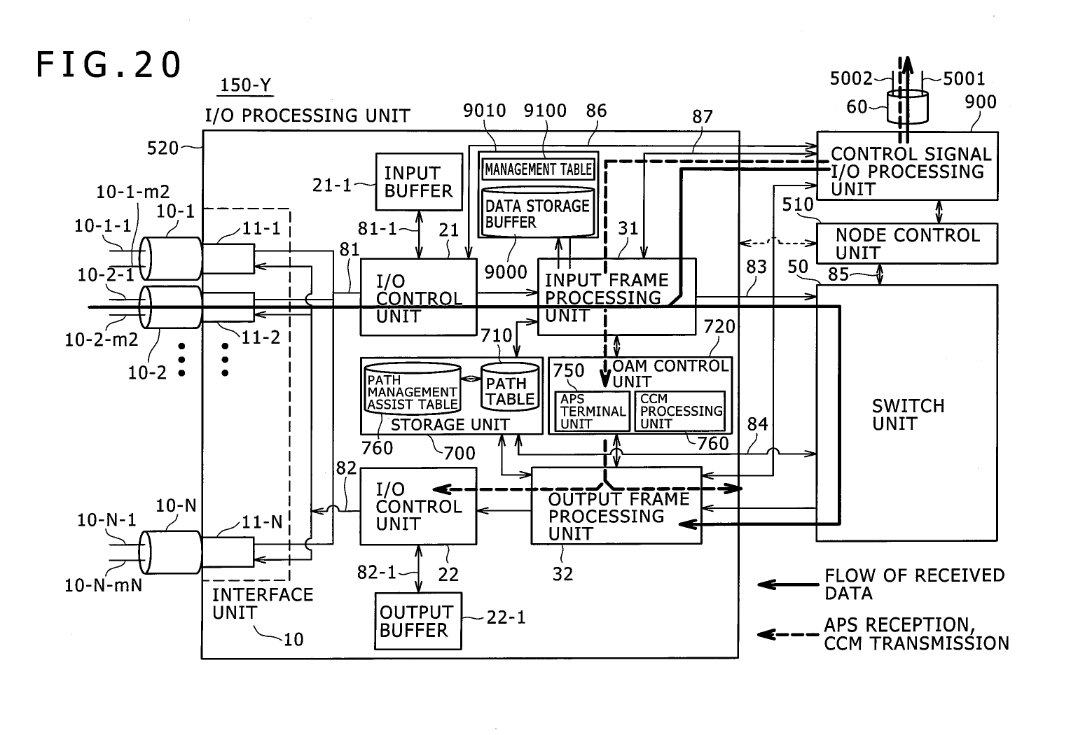

FIG. 20 is a functional block configuration diagram of the TN-Y (150-Y) in a system of FIG. 19. The basis functional block is identical with the configuration diagram of FIG. 5. In FIG. 20, for the purpose of temporarily accumulating the user data in the TN-Y (150-Y), the configuration includes the data accumulation buffer 9000, a data management table 9100, and a data accumulation control unit 9010 that controls those data accumulation functions. The data accumulation control unit 9010 is connected to the input frame processing unit 31, and stores the user data received through the I/O control unit 21, in the data accumulation buffer 9000 prior to transfer processing of the user data. The data management table 9100 manages data within the data accumulation buffer 9000 in association with identifiers of the stored user data, and time at which the relay device (TN-Y (150-Y) in this case) transmits the user data. The data management table 9100 has a function of managing the storage time for each of the user data held in the data accumulation buffer 9000.

The user data whose storage time expires is erased from the data accumulation buffer 9000. Alternatively, in the implementation that conducts transmission waiting for a given time, the data is read from the data accumulation buffer 9000, and transmitted at a time when the storage time is completed by the data management table 9100. The data read processing may be conducted by the input frame processing unit 31, or may be conducted by the I/O control units 21, 22, and a control signal I/O processing unit 900. Which functional block is assigned to read depends on the implementation. For example, when header processing is completed at the time of storing the data, because the transmission timing of the data has only to be adjusted, it is desirable that the I/O control unit 22 corresponding to the destination interface executes the data read processing. Also, when the traffic is stored in the data accumulation buffer 9000 before conducting the header processing of the input frame, the input frame processing unit 31 reads data from the data accumulation buffer 9000 after a given time, and transmits the data from an appropriate port after conducting the header processing. When the user data is transmitted to the detour path, the transmission is conducted through the control signal I/O processing unit 900.

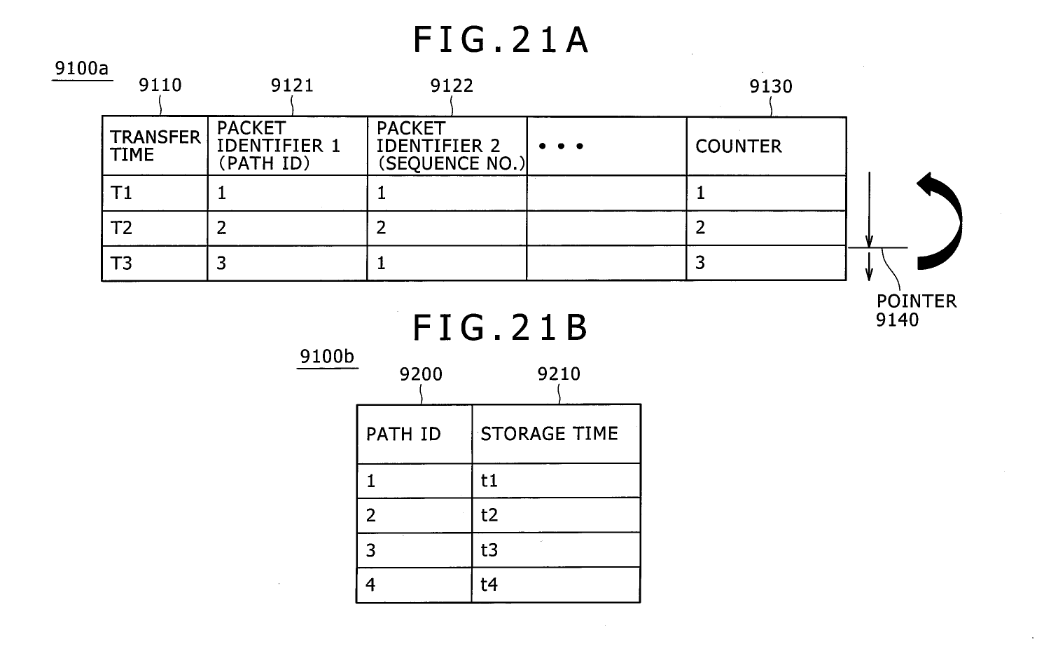

FIG. 21A illustrates a data management table 9100a referred to by the means E. This table includes a transfer time 9110 which is a time at which the received user frame (data) is transmitted from the relay device (for example, TN-Y (150-Y)), and data identifiers 9121, 9122 for identifying the received user frame (data) which is held within the data accumulation buffer 9000. As the implementation of the data identifiers, when the individual frames are identified, the path ID and sequence No. in the frame header, or the combination thereof can be used. Because there is a possibility that the individual frames cannot be identified by only one identifier (in-header parameter), this table includes plural data identifiers 9121 and 9122. As still another identifier, the table includes a counter 9130 and a storage pointer 9140. The storage pointer 9140 is a pointer indicative of a storage location when identification information of the user frame that is newly received by the relay device TN-Y (150-Y) is added to this table. A frame counter disposed within the TN-Y (150-Y) measures the received user frame, and holds a counter value for identifying the measured user frame. When a maximum value of the counter value is set to be sufficiently larger to continue to operate the frame counter, the frames can be distinguished without duplicating the in-device identifier. Specifically, for example, the counter value is stored in the counter 9130 in order from 1. When the user frame is received by the input frame processing unit 31, and stored in, the data management table 9100a, the user frame is stored in order from 1 in the entry of the counter 9130 corresponding to the measured counter value. At the time of storing the user frame in the entry of the counter 9130 corresponding to a maximum value of the frame counter set within the relay device TN-Y (150-Y), the frame counter is cleared and initialized. That is, in FIG. 21A, for example, when the maximum value of the frame counter is set to 3, and the user frame is stored in the entry where the counter 9130 is 3, the user frame subsequently received is overwritten and stored in the entry where the counter 9130 is 1. The implementation of the frame counter can be realized by providing a counter confirmation block within the data accumulation control unit 9010, and confirming the counter confirmation block when storing the received user frame in the data management table 9100a. As another method, there can be used a method of using time information (time stamp; frame arrival time or frame transfer completion time) as the data identifier. The identification unit can be held not on a per frame basis, but as a group (data or content). In this case, the user frames having the same data identifier are grouped, and identifiers such as the sequence Nos., the time stamps, and the counter values are assigned to the grouped data identifiers.

FIG. 21B is a data management table 9100b that stores the storage time of the user data for each logical path which is set on the detour path, and referred to by the means F. The data management table 9100b includes a path ID 9200 of the received traffic (user data), and a storage time 9210 during which the received traffic is held. When the priority and the bandwidth assignment are different, for example, for each path ID 9200 according to the network configuration, or the configuration of a physical line that accommodates a logical line on the detour path is different according to the logical circuit, a required time for path switching, that is, the storage time of the user data is different for each logical path set on the detour path. Even in this case, in order to avoid the data discard, the data accumulation control unit 9010 needs to first inspect the path ID 9200 that receives the traffic, and confirm the suitable storage time 9210. When all of the received user data passes through the same active path and the same detour path, only one entry may be set.

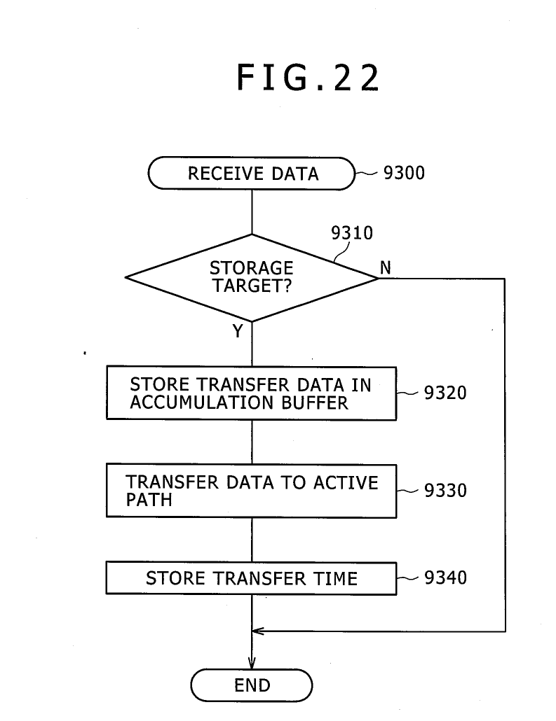

FIG. 22 is a flowchart illustrating a flow of data storage processing of copying the user data in the data accumulation buffer 9000 by the data accumulation control unit 9010. When receiving data from an upstream device on the active path, the relay device first confirms whether the subject data is data to be stored, or not (9310). In this example, the data to be stored is the user data, and the OAM frame such as the CCM frame is exempt from the storage. If the data is to be stored (y in 9310), the user data is stored in the data accumulation buffer 9000 (9320), and the user data is transferred to the active path (9330). Then, the transfer time is stored in the transfer time 9110 of the data management table 9100a (9340).

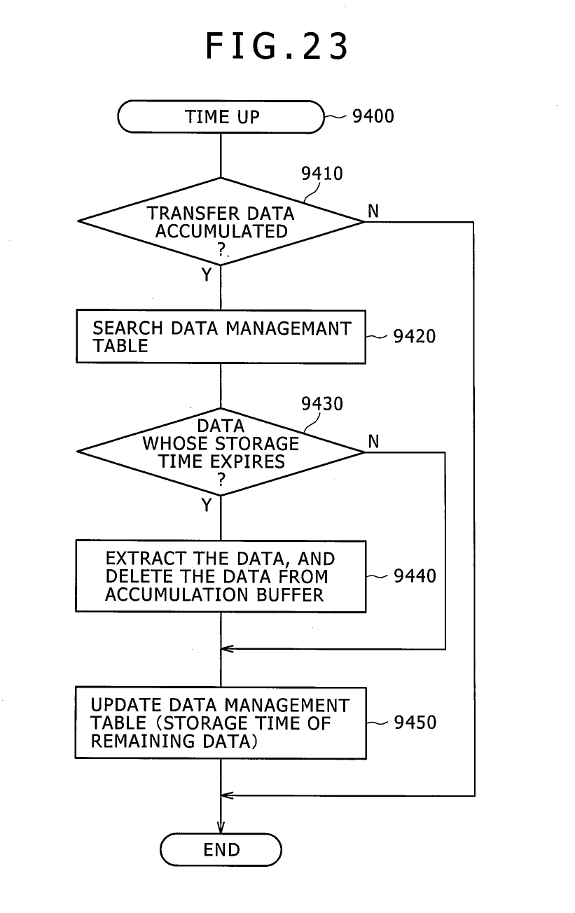

FIG. 23 is a flowchart illustrating a flow of data accumulation processing of setting the storage time until the user data is transmitted, and temporarily holding the user data in the data accumulation buffer 9000 during the storage time by the data accumulation control unit 9010. When a timer that measures the storage time counts up (9400), it is discriminated whether the transfer data is present in the data accumulation buffer 9000, or not (9410). If the transfer data is present (y in 9410), the data management table 9100b is searched (9420), and it is identified whether data of the storage time expiration is present, or not (9430). If the data of the storage time expiration is present (y in 9430), the data is extracted from the data accumulation buffer 9000, and deleted from the data accumulation buffer 9000 (9440), and the data management table 9100b is updated (9450).

Each of the means E and the means F may be executed by referring to the data management table 9100a and the data management table 9100b in FIGS. 21A and 21B.

According to this embodiment, because the data transfer can be restarted for the user with the use of the detour path since the communication failure occurs in the active path until the switching to the backup path is completed, the data communication interruption time recognized by the user can be reduced. The detour path is used as a temporal backup path, and opened after the switching is completed. The control line can be used as the detour path. In this case, because there is no need to ensure the communication apparatus and the communication line for the detour path, a network facility can be economically structured. On the other hand, if the main signal line is used as the detour path, because a wider bandwidth can be ensured than that of the control line, a large volume data transfer can be protected.

### Second Embodiment

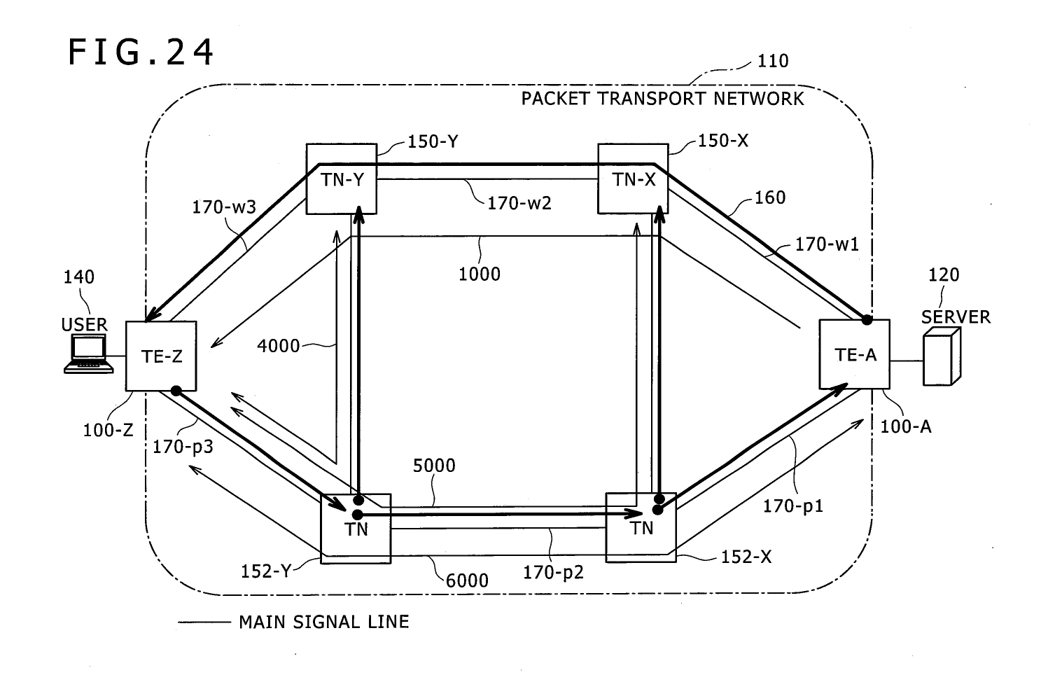

FIG. 24 is a network diagram illustrating a basic configuration of a second communication system assumed in this embodiment. This network diagram is a diagram in which the detour path is set by using not a control plane but a data plane. A description of the constituent elements having the same function already described will be omitted. In this network diagram, detour paths 4000, 5000, and a backup path 6000 are set for the active path 1000. The TE-Z (100-Z) transmits the APS frame through the backup path 6000 in a 5 second period, and notifies the TE-A (100-A) of information related to the path switching. In this example, when receiving the APS frame, a TN (152-Y) can copy the APS frame, and transfer the APS frame to the TN-Y (150-Y) through the detour path 4000. Likewise, when receiving the APS frame, a TN (152-X) can copy the APS frame, and transfer the APS frame to the TN-Y (150-X) through the detour path 5000. Also, a method of referring to the destination to the detour path may be conducted by setting a path table in advance, and transmitting the path table, or may be conducted by broadcast delivery.

When a connectivity failure occurs in the active path 1000 of the TE-Z (100-Z), that is, when the TE-Z (100-Z) never receives the CCM frame from the active path 1000 within a 3.5 period, the TE-Z (100-Z) sets the request/state field of the APS frame, and further changes the transmission period of the APS frame to the backup path 6000 from a 5 second period to a 3.3 msec period. When receiving the APS frame, the TN (152-Y) copies the APS frame, and transfers the APS frame to the TN-Y (150-Y) through the detour path 4000. The TN-Y (150-Y) refers to the request/state field within the APS frame, detects that the failure occurs in the active path 1000, and transfers the subsequently received user data to the detour path 4000.

Likewise, when receiving the APS frame, the TN (152-X) copies the APS frame, and transfers the APS frame to the TN-X (150-X) through the detour path 5000. The TN-Y (150-X) refers to the request/state field within the APS frame, detects that the failure occurs in the active path 1000, and transfers the subsequently received user data to the detour path 5000. Finally, the TE-A (100-A) refers to the request/state field within the APS frame, detects that the failure occurs in the active path 1000, and switches the delivery path from the active path 1000 to the backup path 6000.

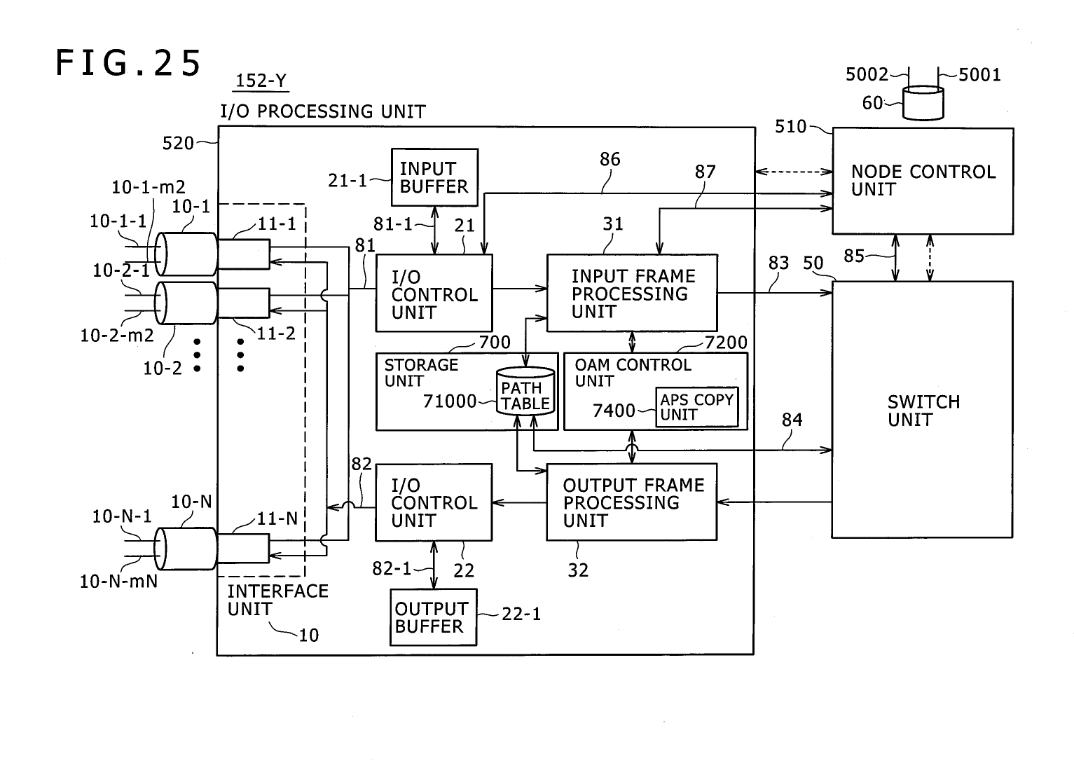

FIG. 25 is a functional block configuration diagram illustrating a device configuration example of the TN (152-Y) or the TN (152-Y). A description will be given of a device management and communication signal processing in the TN (152-Y) with reference to FIG. 25. The same functions as those already described will be omitted.

When the input frame processing unit 31 identifies the APS frame, an APS copy unit 7400 of an OAM control unit 7200 refers to the request/state field of the APS frame. If no failure occurs in the active path 1000, the input frame processing unit 31 transfers the APS frame to the backup path 6000 with reference to a path table 71000. Alternatively, the input frame processing unit 31 may search the destinations of the preset detour path 4000 and the backup path 6000 with reference to the path table 71000, and the APS copy unit 7400 of the OAM control unit 7200 may copy the APS frame, and deliver the APS frame to the destinations.

Also, plural detour paths can be prepared in the path table 71000 in advance. In this case, the path that arrives at the TN-Y (150-Y) most quickly can be used as the detour path. A method of searching the path that arrives at the TN-Y (150-Y) most quickly can be obtained by periodically measuring a transfer time, for example, from the TN (152-Y) to the TN-Y (150-Y). Specifically, the CCM frame in which the transfer time information is embedded in a reserve area is delivered to plural paths from the TN (152-Y) to the TN-Y (150-Y). In the TN-Y (150-Y), a time embedded in the CCM frame is subtracted from a time at which the CCM frame is received with the result that the path delivered from a path having the smallest value can be determined as the path having the most quick transfer time. Also, the copied APS frame can be subjected to broad cast delivery.

When the input frame processing unit 31 identifies the APS frame, if the OAM control unit 7200 detects that the failure occurs in the active path 1000 with reference to the request/state field of the APS frame, the input frame processing unit 31 searches plural preset destinations with reference to the path table 71000, and the OAM control unit 7200 copies the APS frame, and delivers the copied APS frame to the destination.

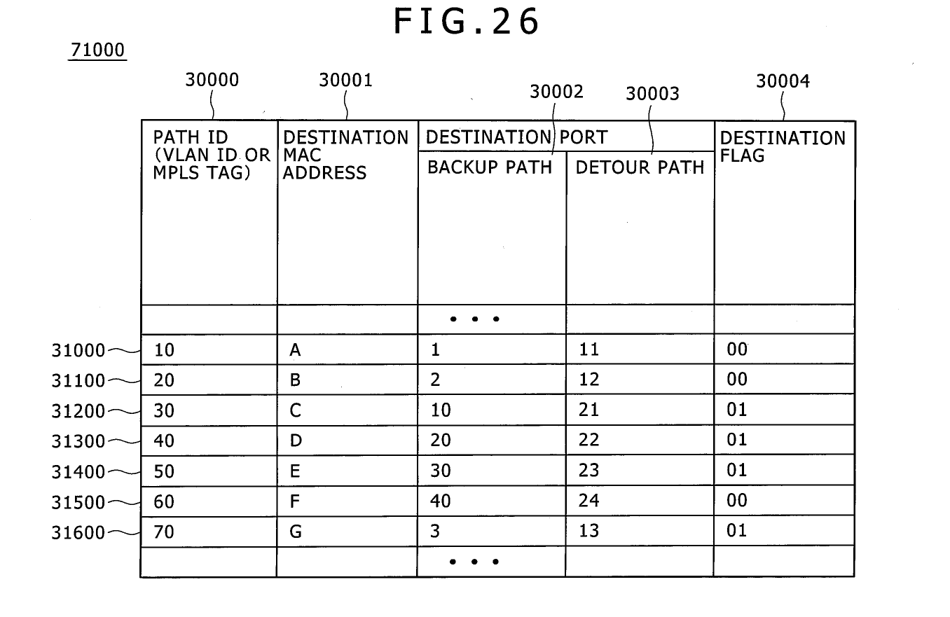

FIG. 26 illustrates the path table 71000 which is held by the storage unit 700 of the TN (152-Y) or the TN (152-X). The path table held by the TN (152-Y) will be described. Reference numeral 31000 to 31600 in this path table represent entries. In the path table are stored a path ID 30000, a destination MAC address 30001, a destination port No. 30002 of the backup path, destination port No. 30003 of the detour path, and a destination flag 30004. When receiving the APS frame, the TN (152-Y) searches the entries on the basis of the path ID 30000. Then, the TN (152-Y) confirms the destination flag 30004. The destination flag 30004 is a flag for determining which path the APS frame is transferred to. For example, in the case of “00”, the APS frame can be transferred to only the destination port No. 30002, and in the case of “01”, the APS frame can be transferred to both of the destination port No. 30002 and the destination port No. 30003.

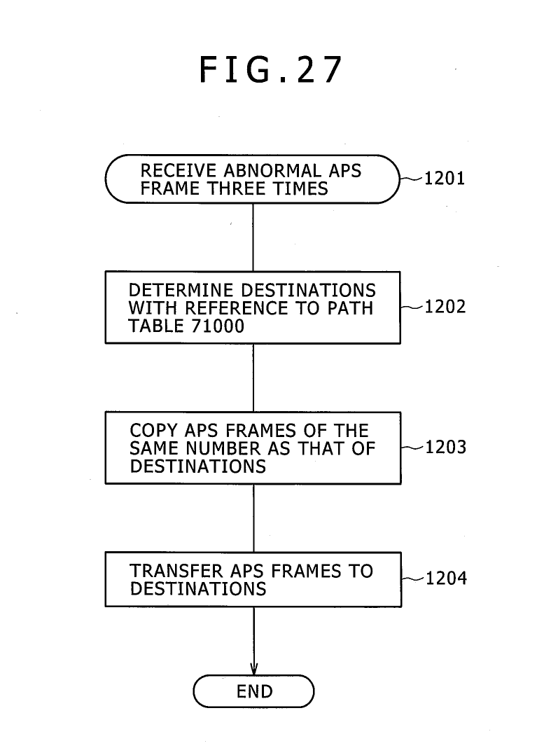

FIG. 27 is a flowchart illustrating the transfer of the APS frame by the APS copy unit 7400 of the OAM control unit 7200 of the TN (152-Y) or the TN (152-X). In this example, the operating procedure of the TN (152-Y) will be described. When the TN (152-Y) receives a frame indicating that the communication failure occurs in the active path 1000, that is, the APS frame having a bit in the request/state field (1201), the TN (152-Y) determines the destination to which the APS frame is delivered with reference to the path table 71000 (1202). Then, the TN (152-Y) copies the APS frame for delivery to the destination (1203), and transfers the APS frame (1204).

In this embodiment, because the bandwidth of the detour path can be ensured with the use of the data plane, a large volume data transfer can be protected. Because there is no need. to ensure the independent detour path from the TE-Z (100-Z) to the relay device, the increased numbers of relay devices and communication lines within the packet transport are suppressed, and a reduction in investment costs and a reduction in management load can be expected. Further, because the TE-Z (100-Z) has no need to have plural ports for transmitting the APS frames (the APS frames arrive at all of the relay devices by one transmission), a large number of relay devices can be used as the detour path switching points.

The present invention is not limited to the above embodiment, but the present invention includes various modified examples. For example, in the above-mentioned embodiments, in order to easily understand the present invention, the specific configurations are described. However, the present invention does not always provide all of the configurations described above. Also, a part of one configuration example can be replaced with another configuration example, and the configuration of one embodiment can be added with the configuration of another embodiment. Also, in a part of the respective configuration examples, another configuration can be added, deleted, or replaced. Also, parts or all of the above-described respective configurations, functions, processors, processing means may be designed by, for example, an integrated circuit as hardware. Also, the above respective configurations and functions may be realized by software by allowing the processor to interpret and execute programs for realizing the respective functions. The information on the program, table, and file for realizing the respective functions can be stored in a storage device such as a memory, a hard disc, or an SSD (solid state drive), or a storage medium such as an IC card, an SD card, or a DVD. Also, the control lines and the information lines necessary for description are illustrated, and all of the control lines and the information lines necessary for products are not illustrated. In fact, it may be conceivable that most of the configurations are connected to each other.

What is claimed is:

1. A communication network, comprising:
a first device;
a second device that transmits a data signal, and transmits and receives a connectivity monitoring signal with respect to the first device, through at least one of a first path and a second path; and
a plurality of third devices that configure the first path, and relays the data signal and the connectivity monitoring signal between the first device and the second device,
wherein when a failure occurs in the first path,
the first device adds information for notifying the failure to the connectivity monitoring signal, transmits the connectivity monitoring signal added with the information for notifying the failure to the second device through the second path, and transmits the connectivity monitoring signal added with the information for notifying the failure to the plurality of third devices through a plurality of third paths which is set between the respective third devices in advance,
when the plurality of third devices receive the connectivity monitoring signal added with the information for notifying the failure through the respective third paths, the third devices switch the data signal from the second device to the first device, which is relayed through the first path, so as to be relayed through the respective third paths, and
when the second device receives the connectivity monitoring signal added with the information for notifying the failure, the second device switches the data signal transmitted through the first path so as to be transmitted through the second path.

2. The communication network according to claim 1,
wherein each of the third devices includes:
a storage unit that holds path information which manages input path identification information for identifying an input path of the received data signal and the received connectivity monitoring signal, first path identification information for identifying a destination of the first path as a destination of the received data signal and the connectivity monitoring signal and second path identification information for identifying a destination of the third paths, and first switching information indicating whether the destination of the received data signal is the first path or the third path, in association with each other; and
a processing unit that outputs the received data signal and the received connectivity monitoring signal to the destination with reference to the path information,
wherein the processing unit of each of the third devices
searches the input path identification information of the path information on the basis of the input path identification information included in the data signal when receiving the data signal from the second device, specifies the destination of the first path according to the first path identification information when the first switching information corresponding to the searched input path identification information indicates the first path, transmits the received data signal to the specified destination of the first path, specifies the destination of the third path according to the second path identification information when the first switching information corresponding to the searched input path identification information indicates the third path, transmits the received data signal to the specified destination of the third path, searches the input path identification information of the path information on the basis of the received input path identification information included in the connectivity monitoring signal added with the information for notifying the failure when receiving the connectivity monitoring signal added with the information for notifying the failure from the first device through the third path, and updates the first switching information corresponding to the searched input path identification information to indicate the third path.

3. The communication network according to claim 2,
wherein the storage unit of each of the third devices holds management information which manages the input path identification information, and relay availability information for specifying whether the received data signal is relayed, or not, in association with each other, and
wherein the processing unit of each of the third devices
searches the input path identification information of the path information on the basis of the input path identification information included in the data signal when receiving the data signal from the second device, searches the input path identification information of the management information on the basis of the input path identification information included in the data signal when the first switching information corresponding to the searched input path identification information indicates the third path, specifies the destination of the third path according to the second path identification information of the path information corresponding to the input path identification information included in the received data signal when the relay availability information corresponding to the searched input path identification information indicates that the relay is available, and relays the received data signal to the specified destination of the third path.

4. The communication network according to claim 2,
wherein each of the third devices includes a measurement unit that measures traffic of the third path,
wherein the storage unit of each of the third devices holds first management information for managing the input path identification information, a priority, and relay availability information for specifying whether the received data signal is relayed, or not, in association with each other, and second management information that manages the traffic of the third path and the priority in association with each other, and
wherein the processing unit of each of the third devices
searches the input path identification information of the path information on the basis of the input path identification information included in the data signal when receiving the data signal from the second device, searches the input path identification information of the path information on the basis of the input path identification information included in the data signal when the first switching information corresponding to the searched input path identification information indicates the third path, specifies the second path identification information of the destination information corresponding to the searched input path identification information, acquires the traffic of the third path indicated by the specified second path identification information from the measurement unit, searches the traffic of the third path of the second management information on the basis of the acquired traffic of the third path, specifies the priority of the first management information of the priority higher than the priority corresponding to the searched traffic of the third path, or the priority equal to or higher than the priority corresponding to the searched traffic of the third path, updates the relay availability information corresponding to the specified priority to information that the relay is available, specifies the priority of the first management information on the basis of the input path identification information included in the received data signal, and relays the received data signal to the third path indicated by the specified second path identification information when the relay availability information corresponding to the specified priority indicates that the relay is available.

5. The communication network according to claim 1,
wherein the first device includes:
a storage unit that holds path information which manages input path identification information for identifying an input path of the received data signal and the received connectivity monitoring signal, and second switching information for specifying whether the received data signal is received through the third path, or not, in association with each other;
a processing unit that outputs the received data signal and the received connectivity monitoring signal to the destination with reference to the path information; and
a control signal processing unit that transmits and receives the control signal,
wherein the processing unit searches the input path identification information of the path information on the basis of the input path identification information included in the data signal when receiving the data signal when receiving the data signal, and processes the received data signal in priority to the received other data signal when the second switching information corresponding to the searched input path identification information indicates the third path.

6. The communication network according to claim 1,
wherein the third path includes a plurality of fourth devices that control the first device, the second device, and the plurality of third devices according to a control signal.

7. A device, comprising:
a processing unit that receives a data signal, and transmits and receives a connectivity monitoring signal through at least one of a first path and a second path, and transmits and receives a control signal through a third path; and
a storage unit that holds path information which manages input path identification information for identifying an input path of the received data signal and the received connectivity monitoring signal, and switching information representing whether the received data signal is received through the third path, or not, in association with each other, wherein when a failure occurs in the first path,
the processing unit adds information for notifying the failure to the connectivity monitoring signal, searches the input path identification information of the path information on the basis of the input path identification information included in the data signal when receiving the data signal after transmitting the connectivity monitoring signal added with the information for notifying the failure through the second path and the third path, and processes the received data signal in priority to the received other data signal when the switching information corresponding to the searched input path identification information indicates the third path.

8. A device, comprising:
a processing unit that transmits and receives a data signal and a connectivity monitoring signal through a first path, and transmits and receives a control signal through a second path; and
a storage unit that holds path information which manages input path identification information for identifying an input path of the received data signal and the received connectivity monitoring signal, first path identification information for identifying a destination of the first path as destination information for identifying the destination of the received data signal and the received connectivity monitoring signal and second path identification information for identifying a destination of the second path, and switching information representing whether the received data signal is the first path or the second path, in association with each other,
wherein the processing unit
searches the input path identification information of the path information on the basis of the input path identification information included in the received data signal when receiving the data signal through the first path, specifies the destination of the first path according to the first path identification information when the switching information corresponding to the searched input path identification information indicates the first path, transmits the received data signal to the specified destination of the first path, specifies the destination of the second path according to the second path identification information when the switching information corresponding to the searched input path identification information indicates the second path, transmits the received data signal to the specified destination of the second path, searches the input path identification information of the path information on the basis of the received input path identification information included in the connectivity monitoring signal when receiving the connectivity monitor signal added with a failure notification for notifying that a failure occurs in the first path through the second path, and updates the switching information corresponding to the searched input path identification information to indicate the second path.

9. The device according to claim 8,
wherein the storage unit holds management information which manages the input path identification information and transmission availability information for specifying whether the received data signal is transmitted to the destination, or not, in association with each other, and
wherein the processing unit
searches the input path identification information of the path information on the basis of the input path identification information included in the data signal when receiving the data signal, searches the input path identification information of the path information on the basis of the input path identification information when the switching information corresponding to the searched input path identification information indicates the second path, specifies the destination of the second path according to the second path identification information when the transmission availability information corresponding to the searched input path identification information indicates that the transmission is available, and transmits the received data signal to the specified destination of the second path.

10. The device according to claim 8,
wherein the storage unit holds management information which manages a priority and a transmission availability information for specifying whether the received data signal is transmitted to the destination, or not, in association with each other, and
wherein the processing unit
searches the input path identification information of the path information on the basis of the input path identification information included in the data signal when receiving the data signal, searches the priority of the management information on the basis of the priority included in the data signal when the switching information corresponding to the searched input path identification information indicates the second path, specifies the signal availability information corresponding to the searched priority, specifies the destination of the second path according to the second path identification information of the destination information when the specified transmission availability information indicates that the transmission is available, and transmits the received data signal to the specified destination of the second path.
